(19) United States
(12) Patent Application Publication
(10) Pub. No.: US 2002/0166123 A1
(43) Pub. Date: Nov. 7, 2002

(54) Enhanced television services for digital video recording and playback

(75) Inventors: Joseph A. Schrader, Los Altos, CA (US); Jeffrey D. Crawford, San Francisco, CA (US); Todd B. San Jule, Palo Alto, CA (US); Alvin P. Lee, Oakland, CA (US); Andrew M. Simms, Sunnyvale, CA (US); Samuel T. Scott, Los Gatos, CA (US); William M. Crow, Mariposa, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/052,111

(22) Filed: Jan. 17, 2002

Related U.S. Application Data
(63) Continuation-in-part of application No. 09/903,973, filed on Jul. 12, 2001.
(60) Provisional application No. 60/273,139, filed on Mar. 2, 2001.

(51) Int. Cl. H04N 5/445; G06F 13/00

(52) U.S. Cl. 725/58; 725/52

(57) ABSTRACT

A television service enables enhance Digital Video Recording (DVR) capability by providing content in conjunction with broadcast television programming. The content is associated with the broadcast television programming to enable record and/or playback one or more programs in various modes of operation.

### CROSS REFERENCE TO RELATED APPLICATIONS

This application is a continuation-in-part of application Ser. No. 09/903,973, filed Jul. 12, 2001, entitled “Enhanced Television Services”. The subject matter of that application is incorporated herein by reference in its entirety.

### FIELD OF THE INVENTION

The present invention generally relates to manipulating data in entertainment systems and services, and more particularly, the invention relates to Digital Video Recording (DVR) and playback services and systems.

### BACKGROUND OF THE INVENTION

Television programming has conventionally been accessed through communication channels including airwave broadcast, cable providers, and satellite transmission. Such services provide viewers a wide variety of entertainment, sports, news, advertisements and educational programming. They typically offer numerous television programs at any given time.

To enable navigation through a listing of available programs, known services supply Electronic Programming Guide (“EPG”) data to the viewer. The EPG is presented to the viewer as a static listing of available programming. The EPG data is periodically updated and then downloaded to the user, and thus enables a viewer to search for a particular program of interest. However, with the large amount of programming available, it is often difficult for the viewer to make an informed decision concerning the most desirable programming at any particular time, even with the use of the EPG. That is because known filtering mechanisms, even if used to present EPG data, often provide an unsatisfactory viewer experience due to the volume of information that is presented. Additionally, the data itself is often stale by the time the programming is broadcast. This is particularly true for televised sporting events which do not always actually occur during their scheduled times. Thus, the information provided by the EPG does not always accurately reflect what is being broadcast.

Interactive programming experiences have also been made available to viewers through use of a set-top box, or of other similar computing devices. Interactive programming experiences are intended to enable a viewer to participate in or create a perception that the viewer is actually participating in the television broadcast. In some instances, interactive programming allows a viewer to play along with participants in a game show by simultaneously answering questions and accumulating prizes and the like. Additionally, interactive programming experiences allow viewers to obtain a more thorough understanding of a particular television broadcast. The set-top box enables such experiences by connecting with a Web site to obtain information relevant to a broadcast and then rendering the obtained content on a display in place of or in connection with the television broadcast. For example, the set-top box may connect to a sports-related Web site to obtain information such as a quarterback's passing efficiency rating or other statistics.

Although programming services are now available to provide EPG data and interactive programming experiences in some form, these services suffer from various deficiencies. For example, these services cannot readily convey information concerning other broadcast programming that may be of interest to the viewer based on the programming currently being viewed. Since there is now no adequate way to bundle information across multiple programs, the types of programming and data provided by known services are not truly ubiquitous. Instead, each program is isolated from other programs even though groups of programs may be of general interest to the viewer. Program enhancements are now provided in program-specific content streams. Different data providers offer inconsistent content representations of these enhancements. It is therefore impractical to retrieve and aggregate these content streams due to the overhead requirements that would be imposed, namely, 1 to n tuners for each of the content streams. This prevents browsing the delivered content as a more general, non-program-specific guide. In many instances known services offer too many choices without the benefit of filtering the available programming to the personal tastes of the viewer in such a way that the user can easily make informed decisions.

In addition to interactive programming, services such as digital video recording (DVR) have recently been made available. While they provide viewers a greater degree of freedom, DVR services also now suffer various shortcomings. For example, DVR recordings do not adequately enable viewers to locate desired portions of the recording. The “rewind” and “fast forward” operations in DVR services and devices are limited to fixed time intervals, typically a 30 second interval forward and a seven second interval rewind.

It would be desirable to have systems and methods that permit users to exert a greater degree of control over the television viewing experience. Moreover, it would be desirable to provide a system and service in which data, such as real-time data, may be linked with broadcast television programming in order to deliver an enhanced programming experience.

### SUMMARY OF THE INVENTION

The present invention provides an enhanced television viewing experience to users in a system and method that utilizes real time and/or other data that is linked together with broadcast television programming. The invention provides Digital Video Recording (DVR) and playback services through the creation of DVR-specific content that is used by one or more client systems. The DVR-specific content includes one or more event logs corresponding to the occurrence of events in the programming. In some instances, the event logs are created in accordance with program rules developed for a particular type of event.

The invention is also directed to a data management system that enables context-sensitive navigation through a recorded program. The data management system provides features such as an “intelligent skip” based on a logical determination of the appropriate program segment during playback. To create this feature, the management system receives event logs concerning the occurrence of events in the program and, in some cases, other control data concerning the program. The system then associates the received event logs with corresponding video segments to create context sensitive indices of the recorded program. During playback, the system uses the program indices to determine the stored video segment to play. The indices may also be associated with received video streams in real-time to enable the viewer to logically jump to desired locations in the video stream.

The enhanced content permits the creation of additional recording features such as a “record adjust”0 feature which informs the client system to adjust the record time for a particular program. This feature may be implemented as a tunable alert in which a unique identifier provided with enhanced content enables an association between the content and a received program. Thus, the program record time may be adjusted when the televised event extends beyond its anticipated time or has completed prior to its anticipated time.

### BRIEF DESCRIPTION OF THE DRAWINGS

FIG. 1 is a block diagram representation of a client-server system in one operative environment of the present invention;

FIG. 2 is a block diagram representation of another illustrative operative environment for the present invention;

FIG. 3 is a data structure corresponding to the general data types that are transmitted from a server to one or more client systems according to the invention;

FIG. 4 is a block diagram representation of certain components that may be used the server-client system shown in services in the embodiments of FIG. 1;

FIG. 5 is a block diagram representation of an illustrative client system that may be used in the embodiments of FIG. 1 or FIG. 2;

FIG. 6 is a flow chart illustrating certain operational aspects of a sports content aggregator component as shown in FIG. 4;

FIG. 7a is a flow chart illustrating certain operational aspects of an application executing on the client system shown in FIG. 5 according to one embodiment of the invention;

FIG. 7b is a flow chart illustrating certain operational aspects of an application executing on the client system shown in FIG. 5 according to another embodiment of the invention;

FIG. 8 illustrates a first navigation guide deliverable to a viewer;

FIG. 9 shows another navigation guide that has a layout similar to that shown in FIG. 8;

FIG. 10 is a navigation guide according to another embodiment of the invention;

FIG. 11 shows a navigation guide that has been updated based on user selection of a navigation element presented in the screen shown in FIG. 10;

FIG. 12 is a navigation guide that is similar to that shown in FIG. 11;

FIG. 13a is a navigation guide illustrating a first Alert being presented to the viewer;

FIG. 13b is a navigation guide that is similar to FIG. 13a in that a second type of Alert is presented to the viewer;

FIG. 14 is a display screen showing information concerning future recordable events according to another feature of the invention;

FIG. 15 is another navigation guide showing preview information;

FIGS. 16a-16c illustrate a memory and directory structure including entries concerning recorded programs and associated data files;

FIGS. 17a-17c are similar to FIGS. 16a-16c and illustrate a memory and directory structure according to another embodiment of the invention;

FIGS. 18a-18b show user interfaces that may be used in conjunction with the DVR features of the invention for playback of sporting events;

FIG. 19 is a user interface that may be used in conjunction with the DVR features of the invention for playback of news events;

FIG. 20 is a user interface that may be used in conjunction with the DVR features of the invention for playback of music videos; and

FIG. 21g is a user interface that may be used in conjunction with the DVR features of the invention for selecting movies.

### DETAILED DESCRIPTION OF THE INVENTION

The present invention relates to systems and methods for delivering television programming and related content to a viewer to enable an enhanced program viewing experience. More specifically, the invention provides a navigation service that supplies Internet protocol (“IP”) data and broadcast television programming. The IP data is linked with the broadcast television programming and presented in such a way as to permit an informed choice to be readily made by the viewer. In one embodiment, the invention segregates a video display into various display areas including a navigation display portion and a program display portion. The navigation display portion presents IP data that has been filtered in accordance with currently available selections of a specific type of programming. Selecting a navigation element within the navigation display portion causes the system to tune to the television program corresponding to the selected navigation element and to display that program in the program display portion. By linking or associating parallel sources of data in this fashion, the viewer can tune to one or a multiplicity of television programs based on an informed choice presented on the display.

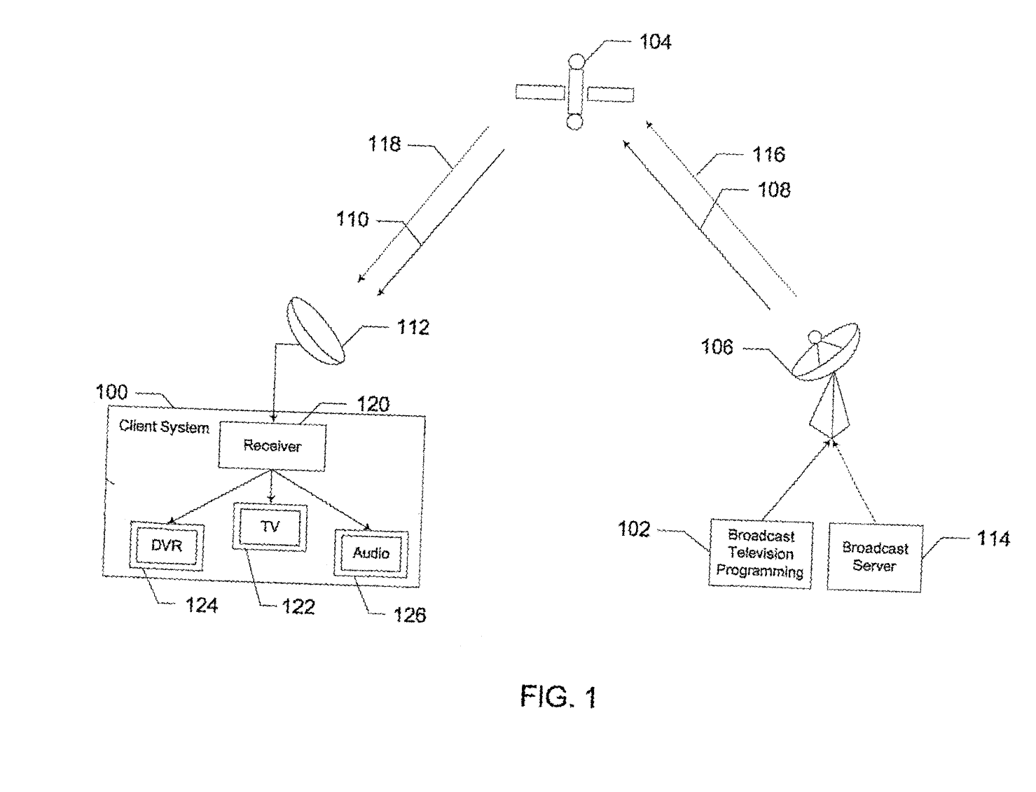

FIG. 1 illustrates a block diagram representation of a suitable environment in which a navigation system 100 according to the present invention is implemented. In this embodiment, a server-client system is operable to provide broadcast television programming and Internet protocol (IP) data over different broadcast channels. As used herein, IP data is intended to refer to data that is packaged in accordance with a protocol that informs the transmission network how data packets are addressed and routed. Those skilled in the art will appreciate that, while the invention is described primarily in the context of providing IP data in parallel with a broadcast channel, other types of data may be transmitted as well. That is, the invention may be incorporated in any environment in which data streams are intended to be associated with television programming in some way.

As shown in FIG. 1, television programming, as denoted by the functional block 102, is broadcast to one or more client systems via a broadcast network denoted by a digital satellite system 104. In particular, the available television programming is up-linked via a transmitter 106 to the satellite system 104 over a communication channel 108. In this point-to-multipoint system, the programming is down linked via a data communication channel 110 to a plurality of client systems, one of which is shown as client system 100. A receiver 112, as shown diagrammatically in FIG. 1, captures the programming.

In addition to the broadcast television programming, a parallel data stream, such as an IP content stream related to the programming, is generated by a Broadcast Server 114. The parallel data stream is similarly up-linked to the satellite system 104 via a data communication channel 116. The IP content stream is down linked to the client system 100 via a second downlink communication channel 118. As explained below, the client system 100 in this embodiment comprises a receiver 120 or other similar computing device that decodes and processes the data received from the antenna receiver 112. The client system 100 also includes a display device such as television (TV) 122. Alternate embodiments include Personal Digital Assistants (PDAs), cellular telephones and other computing devices, and optionally other audio/visual equipment. In FIG. 1, this includes an external digital video recorder (DVR) 124 and an Audio system 126.

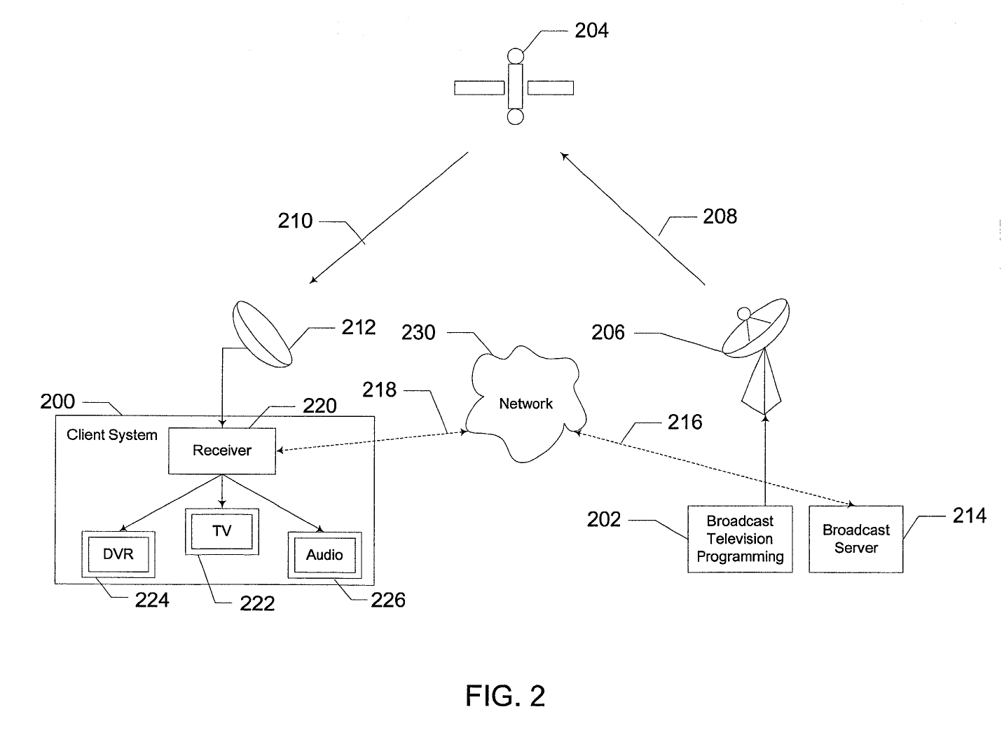

Data services are sometimes transmitted to the client system via a network 230, as illustrated in FIG. 2. This embodiment is similar to the embodiment in FIG. 1 in that broadcast television programming data is up-linked to a satellite system 204 via transmitter 206 over a communication channel 208. The programming data is down linked to the client system 200 via a communication channel 210 to antenna receiver 212. However, in FIG. 2, IP content is transmitted to the client system 200 via the Wide Area Network (WAN) network 230 through network connections 216 and 218. The client system 200 also accesses the server 240 via network. The client system 200 also includes a digital video recorder 224, a television device 222 for displaying and an audio device.

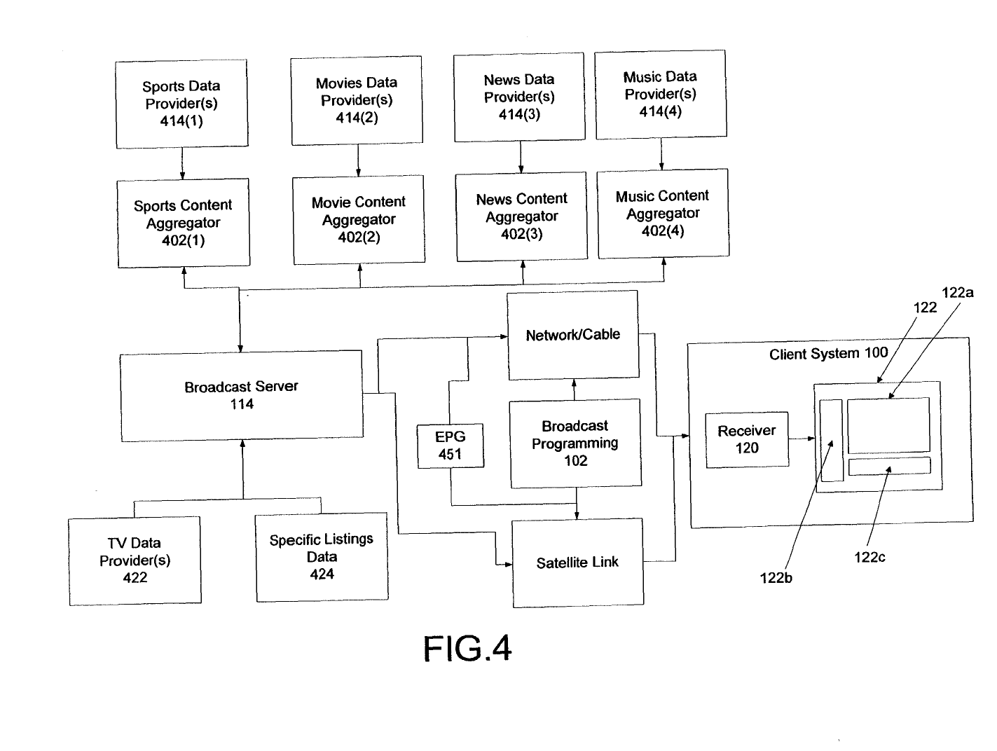

While FIG. 1 and FIG. 2 illustrate delivery of television programming via a satellite system, such programming may alternatively be delivered via a cable television system. In one embodiment of the invention, television programming is provided through a digital cable system that delivers multiple channels of video data in a compressed format, such as MPEG II format. Other broadcast television systems may be used. Thus, FIG. 4 shows delivery of broadcast programming through either (or both) a satellite link or through a network/cable system.

For both the satellite and digital cable embodiments, data services in the form of enhanced IP content may be provided to the client systems in a dedicated data communication channel. In this embodiment, the Broadcast Server 144 or head-end pre-allocates the bandwidth to accommodate the data services in a channel or bundle of channels that are reserved for exclusive use of these services. However, data services may be transmitted in any manner. For example, such data services may be interleaved with the television programming. That is, for both the satellite and digital cable embodiments, data services may be inserted into the MPEG video stream in the form of a “trickle stream” of IP data. The use of a trickle stream avoids the allocation of additional communication channels.

To reduce the bandwidth, the generated trickle stream preferably contains only dynamic content such as real-time event notifications and program updates. Other content may be periodically transmitted either via a separate broadcast data communication channel or via the WAN. This embodiment may be used where bandwidth at the server or head-end is not pre-allocated. The use of a trickle stream further provides advantages on the client side since a tuner need not be tuned to the channel delivering the IP content to obtain the enhanced services. This results in greater viewer option and control over the television viewing experience.

Other transports may be used to deliver the enhanced data stream. By way of example, a non-program synchronous Advanced TV Enhancement Forum (“ATVEF”) transport may be used in some instances.

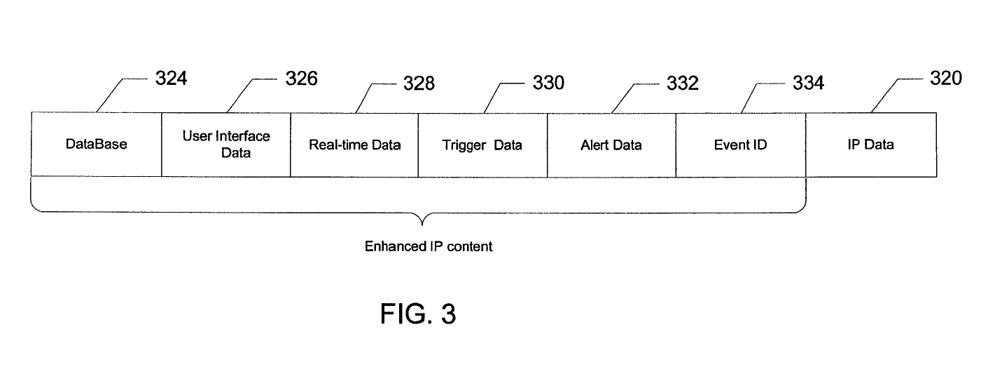

FIG. 3 illustrates an exemplary data structure for such data services. An IP data header 320 specifies network protocol information, information concerning transfer between applications, and an appropriate encoding method, for example, NTSC compliant encoding. The IP data 320 encapsulates information concerning one or more television programs. Such data generally includes a portion of a television transport stream that contains database information 324 and/or user interface information 326 for creating an enhanced navigation tool to permit the viewer to perform an informed search for a particular program. This information may be packaged as HTML files or other types of data files.

As explained below, the enhanced IP data is sometimes augmented with, among other things, real-time data 328, trigger data 330 and Alert data 332. “Enhanced IP data” refer to any type of data that includes associated identification data or can be associated with a particular television program in some fashion. In any event, such data is coupled with identification data, shown in FIG. 3 as an Event Identifier 334, associating the data packet with a corresponding television program. The Event ID is an ID that associates any type of enhanced IP data to a television program. The Event ID may be created by using a custom ID that is assigned to IP data, the Event ID may be created by mapping heterogeneous Ids previously assigned to IP data or broadcast programming into a single homogeneous Event ID system, or the Event ID may be derived from or be the same as a pre-existing universal ID system, if one is available.

Thus, in accordance with the present invention, for each television program that is available through this service, an Event Identifier for the program is also provided. In one embodiment, then, an enhanced television schedule is created and periodically downloaded to the client systems. Each entry in the enhanced television schedule includes an Event Identifier, an event time and a market identifier corresponding to the channel number or tuner position for a particular local television market.

For creating an enhanced user experience, the IP data is augmented in some fashion before it is routed to the client system. For example, real-time event data relating to the active status of available television programming may be inserted in the IP stream and provided to the client system. Such data is used to create various real-time tunable alerts, triggers or filters and the like. The client system processes such data to create real-time visual indicators and cues and presents the visual indicators and cues together with IP data. Thus, for example, data corresponding to current status indicators of available sporting events and for invoking specific actions are provided to the client system. As explained below, the real-time data may be transmitted as event-based Extensible Markup Language (XML) representations. In one embodiment, such enhanced IP data is routed to the client systems through the transmission of IP encapsulated data from a server. The server is a dedicated server in one embodiment. Alternatively, the server may be located at the head-end of various cable operators, for example, the server 112 illustrated in FIG. 1 or the server 212 in FIG. 2. The XML event data is sometimes supplied to the client systems independent of the enhanced sports schedule data, but may be used in conjunction with such data in other embodiments.

The communication channel 221 shown in FIG. 2 may also be used as a back-channel to enable the initiation of requests for Internet services by the client system 200. In this way, additional data concerning the programming currently being broadcast may be retrieved from the Internet and provided to the viewer as well. For example, the data may permit the viewer to connect to a related web site to obtain relevant information concerning the broadcast.

In an embodiment relating to the delivery of information related to sporting events, a data provider and/or broadcast server create the real-time and other content that is delivered to the client system. As explained below, a sports content aggregator creates a normalized data stream that includes an Event Identifier associated with each sports related event or meta data provided by external sports data providers. The content aggregator transmits the normalized data stream with prioritization to a broadcast server. The normalized data stream preferably conforms the various data received by the sports content aggregator to an API being used by the broadcast server. The broadcast server then matches a local line-up data to the Event Ids being transmitted by the content aggregator to create a new themed programming schedule indexed by Event ID, in this example, the theme being sports. The content aggregator receives data from external sources that has no data ID or its own unique data ID. The content aggregator maps the data to a single Event ID system, and transmits the normalized data to the broadcast server as indexed by Event ID.

Alternatively, the content aggregator receives the external data already mapped to a single Event ID system. The broadcast server then periodically supplies the updated enhanced schedule to the client systems. When a sporting event is being broadcast, the content aggregator aggregates and normalizes various live data feeds to generate certain real-time event notifications, alert notifications and other data that are mapped to an Event Identifier. This enables a client system to manipulate such data to present, among other things, tunable alerts and other real-time indicators that have previously been associated with an appropriate Event Identifier. In response to selecting such a tunable alert, the client system tunes the television to the channel corresponding to the Event Identifier. The client system also uses such data to indicate other information, such as status information indicating that a particular game is active, inactive or has extended beyond a previously scheduled time.

As shown in FIG. 4, a Broadcast Server 114 operates in conjunction with several components to create the data services associated with the television content stream delivered to the client systems. Various content aggregators 402 generate normalized data feeds corresponding to various events or pieces of content that may be available for viewing. For example, the Sports Content Aggregator 402(1) receives various data feeds based on events that occur in the televised games of interest from external Sports Data Providers 414(1). The data feeds include, for example, sports status real-time data, sports statistics and editorial data from Internet data services such as STATS, Inc™ the Associated Press™, and the like. The Data Providers 414 may be external to the Content Aggregator 402 or portions may be a part of the Content Aggregator 402. As explained below, in one embodiment, the Content Aggregator 402 also receives a plurality of Event Identifiers, each of which corresponds to a particular event or piece of content of interest. Alternatively, the Content Aggregator 402 receives data Ids and the data Ids are then later matched with an Event ID by the Broadcast Server 114, or the Content Aggregator 402 receives data without Ids and transmits the data to the Broadcast Server 114, which then assigns an Event ID to the data.

In one embodiment, the Content Aggregator 402 then processes the data feeds by assigning priority properties. In particular, information that is considered to be dynamic content, such as real-time indicators, alerts, and scoreboard status changes, are assigned with high priority. A next priority level, such as a “Fast” priority, is assigned to information such as the box scores of games currently in progress. A “Normal” priority is assigned to information that typically changes on a daily basis, such as news events relevant to a program of interest. Finally, a “Low” priority is assigned to content such as pictures, schedules, or other relatively static information concerning the program of interest.

Assignment of different priority levels to the received data feeds enables the Sports Content Aggregator 402(1) to manage the bandwidth of the various data streams more efficiently and conveniently. In the described embodiment, the Content Aggregator 402 sorts and groups the incoming data feeds according to assigned priority levels. The sorted and grouped data feeds are then output to the broadcast server 114, responsive to the assigned priority levels. In one embodiment, multiple data transmission channels are used to transmit the different priority data. For example, a “High” priority data feed transmission; a “Fast” priority data feed transmission, a “Normal” priority data feed transmission; and a “Low” priority data feed transmission may all be used to transmit the data in accordance with the present invention. Thus, the data feeds may be simultaneously transmitted according to their priority levels. In this embodiment, each of the data transmission channels is implemented independent of other channels. Alternatively, a single transmission is generated that accommodates all of the different prioritization levels. The data transmission channels are implemented as either logical channels or physical connection channels. In general, the dynamic content streams associated with real-time events in the sports telecasts are used to generate real-time indicators on the client side to enable a tunable Alert or indicator. However, such real-time data may also be used to invoke some other action.

In addition to dynamic content concerning the current status of various sporting events, the Sports Content Aggregator 402(1) also generates a game log of indices of those sporting events according to predetermined game rules that apply to particular sporting events. The indices are created from the various data feeds provided by the Sports Data providers 414, and include data concerning game play such as when a ball is snapped, when a time out is called, and the like. Then, by way of example, to index a football game, the Content Aggregator 402 creates XML representations of game segments. In this example, a first game rule may require a log to be captured each time the football is placed into play, i.e., each time the ball is placed into play from scrimmage and for any kick-off. A second rule may require a log to be captured whenever the whistle blows ending a play, or some preselected time thereafter. In this way, the Content Aggregator 402 creates real-time DVR data that may be utilized by a client application to permit a “smart skip” or “intelligent skip” forward and backward DVR playback to enable a viewer to jump between plays of interest, among other logical skips or jumps in the recorded video.

The event logs are sometimes collected and transmitted to the client systems as a file or a collection of files. Although many formats may be used, in one embodiment the Sports Content Aggregator 402(1) creates an index file including XML-based event logs in accordance with a defined schema. The index file also includes various control data. Exemplary tagged control data entries for an exemplary index file capturing a college football game involving UCLA versus Washington State, are shown below:

<version>0.1</version>
-<metadata>

-<theme>

<category>sports</category>
<subcategory>football</subcategory>
-<sport>

<type>football</type>
<league>College</league>
-<team>

<type>home</type>
<name>UCLA</name>
<nickname>Bruins</nickname>
<abbreviation>Bru</abbreviation>
<record>0-3</record>

</team>
-<team>

<type>away</type>
<name>WAshington State</name>
<nickname>Cougars</nickname>
<abbreviation>Cou</abbreviation>
<record>2-1</record>

</team>
<location>Pasadena CA</location>
<temperature>80 Degrees</temperature>
<gameid>12345</gameid>

</sport>

</theme>
<storyid>12345</storyid>
-<tvlocation>

<tvtoken>tv:foxsports.com#20001130T091027/+T0300</

tvtoken>

<tmsid>EP4120870008</tmsid>

</tvlocation>
<timestamp>=“04/21/00 5:10:27 PM PCF”</timestamp>
<headline> Washington State at UCLA game log</headline>
<smartplaybackhtmlfile>file://Content/TV/Sports/playback/pla

yback_football.html</smartplaybackhtmlfile>

</metadata>

For each program index file, a plurality of meta-data entries identify various features of the file. In the above example, such data includes a category (sports), a subcategory (football), a league (College football), the identification of teams and logos, game location, weather, and a time stamp. In addition, metadata concerning an associated Control File, in this case a file written in a markup language such as an HTML file, are included in the meta-data entries.

The Sports Content Aggregator 402(1) also creates specific event logs concerning the program, in this case a football game. One exemplary format for these tagged event entries is shown below:

<event id=“ ” play=“ ” kind=“ ” yards=“ ” highlight=“ ”

clock=“ ” start=“ ”>

<description> </description>

</event>

The arguments in the tagged event entries correspond to the following information in this example: an event id. number; the play number; the kind or type of play; the number of yards gained (or lost) on the play; a highlight field; a clock entry corresponding to a time stamp; and a start of play time entry corresponding to a time difference from the start of the event. In addition, a description tag permits inclusion of additional information concerning the event as desired by the service provider. Thus, to represent the opening kickoff of a televised football game, the event log may be represented as follows:

<event id=“4” play=“1” kind=“kickoff” yards=“42”

clock=“13:20” start=“572”>

<description>###</description>

</event>

To represent a game highlight such as a touchdown, an exemplary event log may be represented as follows:

<period id=“1”>

<possession id=“1” pos=“Cou”>

<event id=“10” play=“2” kind=”touchdown” yards=“27”

highlight=“y” clock=“9:34” start=“815”>

<description>WSU Touchdown</description>
</event>

</possession>

</period>

In addition to the tagged entry concerning the event, tagged entries corresponding to the period (the first quarter) and possession (Cougars first possession) are also included. Thus, event logs concerning other game specific events are captured. Other game-specific and/or sports-specific algorithms and rules may be applied to the televised event create different levels of game segments. These may include generating an event log whenever any play results in a yardage gain of more than 20 yards, generating an event log on the occurrence of a turnover, and/or other important events such as scoring plays. These event logs are processed by the client application to enable viewing of highlights or other game segments.

In the football example described above, the following rules are used to classify plays in a football game as highlights. Scoring plays are classified as highlights. These include: (1) a touchdown; (2) field or attempt; (3) extra point or attempt; (4) two-point conversion or attempt; and (5) a safety. Turnovers are also classified as highlights. These include plays involving the following game action: (1) interceptions; (2) fumbles lost; (3) turnover on downs; and (4) blocked punts. Other game play is classified as a highlight as follows: (1) runs of 10 or more yards; (2) passes of 20 or more yards; (3) kick-off returns of 35 or more yards; (4) punt returns of 20 or more yards; (5) sacks; (6) fourth down conversions; (7) successful on-side kicks; (8) penalties 16 or more yards; and (9) 3^{rd} down conversion or failure inside the 20 yard line.

In the currently preferred embodiment, the Sports Content Aggregator 402(1) receives various data feeds from Sports Data Providers 414(1). However, in other embodiments, the Content Aggregator does not generate indices based on the receipt of data feeds from the Data Providers 414(1). Instead, the Content Aggregator creates a series of event logs or DVR indices by parsing a video stream in one or more ways. For example, the Content Aggregator will parse Close Captioned data from the video stream for the desired program. Using the Close Captioned data, the Content Aggregator then builds an index file to transmit to the client systems. Alternatively, or in addition, the Content Aggregator uses ATVEF data to intelligently a received video stream and build an index file. The Sports Content Aggregator can also be configured to intelligently parse a received video signal to search for certain transitions between video frames. From this video data, the Content Aggregator can then build a file of indexes. This is particularly useful where no Close Captioned or ATVEF data exists.

By capturing such event logs, the Sports Content Aggregator 402(1) creates a series of XML representations of segments of the football game. These event logs are packaged as a game index file representing a televised football game in the above example.

In addition to the program index file, the Sports Content Aggregator 402(1) sometimes supplies one or more Control Files to enable the client systems to present a custom user interface during playback. In the above example, the control file is written in a markup language, such as HTML or FLASH 5 from Macromedia, Inc. As explained below, the Control File sometimes includes scripting code and other control data providing additional enhancements such as the presentation of an icon indicating to the viewer that the recording is an “intelligent recording,” or to permit a “skip override” function in which the receipt of a skip input command causes the client system to perform a logical skip, or for other formatting functions such as full screen operation.

The Sports Content Aggregator 402(1) optionally performs various post processing with respect to the game index file to provide further enhancements to the index file and/or control file. This may include post-game analyses and statistical updates, interviews and scheduling content concerning upcoming telecasts.

Such information is transmitted to a client system where it is associated with the recording obtained by the client system. This permits one or more playback modes such as playback of active game play only, playback of specific player participation, or playback of other highlights according to the created game segments. The information may also be used to enable real-time pause, and intelligent skip backward and forward.

The Sports Content Aggregator 402(1) alternatively, or in addition to creating game log index files, transmits a content stream of transient events, such as start of football play events in the above example. As explained below, these transient events are captured and processed by the client systems to enable intelligent skips to be made during live telecasts. For example, if a viewer begins to watch a football game during halftime of the game, then the viewer may skip back to the beginning of the game and watch only highlights or active plays during the first half of the game. Typically, the log information included in the real-time content stream is less than that included in the program index files that are transmitted upon the conclusion of the program. Also the Sports Content Aggregator 402(1) may send log index files at certain points in time during a televised event, such as at the end of each quarter in the above example.

Other information and content, such as pictures, schedules and the like, are assigned with low priority. According to the invention, High priority information is transmitted dynamically, such as via digital satellite. On the other hand, Low priority information may be transmitted via a relatively slower transmission channel, for example, via the Internet. The Content Aggregator 402 also formats the data streams for optimization as a one-way broadcast to a Broadcast Server 114.

The Event Identifiers may be mapped in various ways to the particular sports content streams. In the illustrated embodiment, the Sports Content Aggregator 402(1) functions to normalize the various data streams to an appropriate Event Identifier. In particular, the Content Aggregator 402(1) retrieves Event Identifiers, each uniquely corresponding to a particular sporting event as assigned by one or more sources. These include the sports statistics and/or editorial vendors that provide information to the Content Aggregator 402(1). The Broadcast Server 114 also maintains a database containing line-up entries indexed by Event Identifiers. The Content Aggregator 402(1) also creates new records based on received Event Identification information. In this way, the Content Aggregator 402(1) maps Event Identification data between multiple sources of program information, sports statistics, other broadcast information and enhanced data streams. Alternatively, the Content Aggregator 402(1) maps heterogeneous event ID data into a single homogeneous Event ID system, as discussed previously.

FIG. 4 illustrates additional content aggregators that optionally may be used in accordance with the invention to create Event Ids. As shown, a Movies Service Provider 404, a Music Service Provider 406 and a News Service Provider 408 also provide normalized output data streams to the Broadcast Server 114. That is, for each television program, movie, or other piece of content, the appropriate service provider creates an Event Identifier for each program, event, or piece of content and associates that Identifier with content related to that program, event, or piece of content. For example, each movie in a movie database may receive an Event Id. Then, meta-data related to the movie is also assigned the same Event ID. Such data may include movie reviews, trailers, previews, interviews, etc. In News, events may be assigned Event Ids, such as an election scandal, an AIDS conference, a legislative debate, or the like. Then, meta-data associated with the event is also assigned the same Event ID, including web sites relating to the event, video clips, etc. For Music, a database of songs and artists each may receive an Event ID, and the meta-data relating to songs and artists receive the same Event ID. Other Service Providers 402 for different categories can similarly create Event IDs that associate the programs, events, and contents related to their category with Event Identifiers.

While the Sports Content Aggregator 402 operates as a data “push” model in which the various data feeds are aggregated and transmitted to the Broadcast Server, the service providers (including the Sports Content Aggregator 402) may optionally function in a “pull” model. For example, the Movies Content Aggregator 402 contains a movies database, with enhanced content streams, and associated Event Identifiers. In this instance, the Broadcast Server 114, upon receipt of local listings information, polls the Movies Service Provider 402 for enhanced data corresponding to the local listings.

In one embodiment, after receiving the normalized data stream from Content Aggregators 402, the Broadcast Server 114 receives television listing data specifying the local line-up for a given viewer. Specifically, television data services, such as Tribune Media Service data, are supplied through a data service 422. In addition, data concerning specific program listings provided by local carriers is supplied through a Network Operator Service 424 are provided to the Broadcast server 114. By way of example, the specific listing data provided by this service may include scheduling information corresponding to DIRECTV NFL Sunday Ticket information or the like.

The Broadcast Server then matches the schedule data with the local listing data. In a sports embodiment, the Broadcast server 114 performs the matching by retrieving date, time, team names, and league names from the data accompanying the Event ID of a particular piece of IP data. Then, the Broadcast Server 114 uses conventional fuzzy logic matching to match that with TV listing data which typically comprises date, time, a field indicating whether the event is live, a program description, and a program category. After this matching is performed, the Broadcast Server 114 can create a new enhanced sports schedule that correlates IP data with the local channel line-up of a particular viewing region. For the News Content Aggregator, the matching matches a topic description provided with the Event Ids to program descriptions, and dates of TV listings. Thus, a topic may be an AIDS conference that is occurring on a specific day, and the Broadcast server 114 searches program descriptions for TV listings of that day to identify news programs that are discussing the conference. Once such a news program is identified, it is assigned the AIDS conference Event ID. For Movies, the Broadcast Server 114 matches the Event ID information with titles, date made, and attributes of the movie (such as director's cut, letterbox, and the like) to assign Event Ids to a particular movie that is being broadcast. For all of the matching steps, human editing may also be used as a quality check on automated matching. Then, on a periodic basis, the Broadcast Server 114 generates an updated themed (e.g., sports, music, movies, news, etc) schedule in which the Event Identification data is matched with the local television line-up for a specific market, and transmits updated schedule to the client systems.

The modular architecture employed in this embodiment permits the Broadcast Server 114 to route domain specific television schedule data received from the Service Providers 402, 404, 406, and 408 in the same fashion. Also, the Broadcast Server 114 may customize the schedule data to a specific viewing location. For example, the Broadcast Server is able to match the enhanced data to any changes in local channel lineups since the schedule information is updated daily. This provides advantages over known EPG delivery systems. Since they are updated less often, these systems often mismatch the EPG to local listings, particularly when occurrence of the sporting event is uncertain. The Broadcast Server 114 optionally performs additional localized functions with respect to the normalized data streams received from the Service Providers. However, modularization of these server components is optional.

The Broadcast Server 114 transmits the enhanced and normalized data streams to the client viewers for enhancing the viewing experience, as explained in further detail below. In one embodiment, the Broadcast Server 114 also performs the function of the Content Aggregator 402. In this embodiment, the Broadcast Server 114 receives from the Sports Provider (or other provider) 414 heterogeneous data associated with different enhanced IP data from a variety of sources, television schedule information from a variety of sources (such as a cable provider, a satellite provider, a TV listings service such as the Tribune Media Service, or the like), and create a single sports or other themed schedule that relates the enhanced IP data with the different program listings to create “tunable” IP data. In an alternate embodiment, the different Content Aggregators 402 create enhanced theme schedules by issuing calls to a centralized TV listings database to extract the TV listing information and then maps the extracted TV listings to the Event Ids as discussed above to create an enhanced schedule, which is then transmitted to the Broadcast Server 114 which transmits the schedules to the clients.

The Broadcast Server 114 also preferably manages and schedules the delivery of various formatted content streams. This may be performed by polling, in real-time fashion, the availability of such content based on a set of delivery rules. Thus, for example, the delivery of data supplied by other content sources, such as advertisement information, may be appropriately scheduled.

The Broadcast Server 114 supplies the processed real-time data streams and mapped data enhancements through a transmission medium the client systems, such via the network/cable transmission system or the satellite link to the client system 100 shown in FIG. 4. Other information such as EPG data may also be transmitted over these media. The data streams are received by the receiver 120 and processed for presenting on display device 122. As explained below, the display device 122 is segregated into various display areas including a viewer area 122a for displaying a currently tuned television channel, a dashboard or navigation display area 122b for presenting real-time scores and other statistics and a tunable alert area 122c for providing real-time information that, when selected, enables the client system to tune to the associated channel.

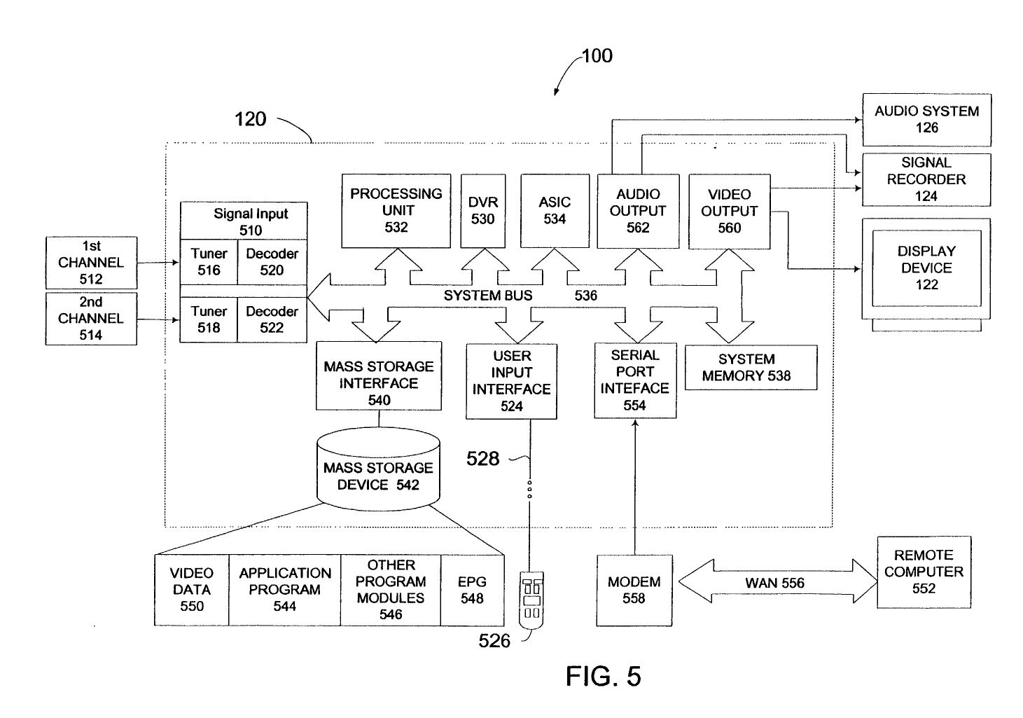

FIG. 5 is a block diagram representation of an exemplary client system 100. The client system 100 is implemented as one or more devices such as a set-top box, cellular telephone, video game console, PDA, or other embedded computing device that is optionally configured to receive broadcast television programming and data services, or to operate in conjunction with other devices so configured. For example, the client system may be implemented as various interoperable devices or nodes, such as in a home network. Thus, a display could be presented via a PDA that communicates with a set-top box including at least one tuner. Input information may be provided to the client system either through the PDA, via the set-top box or through yet another device. In the illustrated embodiment, the client system 100 includes at least one tuner, and preferably includes two or more digital tuners, for receiving digital satellite television programming and/or IP content. The client system 100 also includes advanced digital-video-recording (“DVR”) capabilities. This enables the simultaneous recording of television channels as desired as well as pause, replay, slow motion and picture-in-picture viewing capabilities. The client system 100 facilitates television navigation and viewing, as well as Internet navigation. However, those skilled in the art will appreciate that, while the above features are advantageous, many other client systems may be utilized to implement the invention as well.

The client system 100 provides output video to a display device 122. The display device 122 may be implemented as a high definition television display, a standard television display, a computer monitor, or other device capable of displaying images or video represented by image or video data. The client system also includes an external signal recorder 124 and an audio system 126. The audio system represents a speaker, stereo system, or a device capable of presenting sound represented by sound data.

The client system 100 comprises a signal input module 510, which receives digital television programming and/or other data from first and second data communication channels 512 and 514 via first and second digital tuners 516, 518, respectively. While the programming is preferably transmitted via a digital satellite system (see FIG. 1), such information may also be transmitted via a digital cable system (see FIG. 4), cable or optic connection, a terrestrial antenna system, or any other device or system capable of transmitting programming and IP content to the home client system 100.

When the digital signal includes multiple channels, the first digital tuner denoted by the block 524 tunes to a selected channel in the signal. If only one tuner is utilized, the selected channel includes a trickle stream of IP content to provide enhanced services to the viewer. Multiple digital tuners are preferably used to provide enhanced viewing features, such as picture-in-picture, recording one channel while viewing another, and recording a plurality of channels simultaneously. In the disclosed embodiment of the invention, at least one additional tuner 526 is adapted to receive the digital signal and tune to a second channel. This enables the IP content to be delivered over a separate channel where it is received by the tuner 526. However, even when the client includes multiple tuners, a trickle stream may be included in a selected channel along with television programming to avoid allocation of a tuner to receipt of IP content. This enables the viewer to utilize the additional tuner 526 for viewing and/or recording options, while at the same time receiving the services according to the invention.

A pair of signal decoder modules 520 and 522 converts the received video data into an appropriate data format. For example, the video decoders 522 may decode the received video data stream from a compressed video format (e.g., MPEG-2 format). Thus, although FIG. 5 illustrates the client system 100 as receiving data via two data communication channels 512 and 514, it should be understood that a plurality of programming input lines that transmit programming from a plurality of signal sources may be used. In such embodiments, the client system 100 receives the programming from one signal source or from a plurality of signal sources at a time.

The client system 100 also includes a user input interface 524, which receives input control signals from an input device 526 such as a remote control, a keyboard, a microphone, or other any other device capable of generating electronic instructions for the client system 100. Input device 526 is coupled to the client system over an input link 528 to enable transmission of such control signals. Input device 526 generates electronic instructions over input link 528 in response to preprogrammed data or in response to a viewer pressing buttons on input device 526. Input device 526 also controls web browser software within the client system 100.

FIG. 5 also illustrates a DVR device 530 for receiving video and/or audio data and recording such data on a storage medium. In the illustrated embodiment, the DVR device 530 is contained within the set-top box 120. Alternatively, or in addition to the internal DVR device 530, signal recorders such as recorder 124 may be provided external to the set-top box.

A central processing unit (CPU), illustrated as processing unit 532 in FIG. 5, controls operation of the set-top box 120. The CPU 532 is coupled to an application specific integrated circuit (ASIC) 534 and uses computer executable instructions implemented in software and/or hardwired logic circuitry. The CPU 532 and ASIC 534 are coupled via a system bus 536, which also interconnects various other system components. These include system memory 538, mass storage interface 540, user interface 524, and signal input device 510. The CPU 532 executes software designed to implement features of the client system 100 including features of the present invention. The ASIC 534 contains circuitry that is used to implement certain functions of the system. Instructions, data and other software necessary for the operation of processing unit 532 and the ASIC 534 may be stored in the system memory 538, and/or in a mass storage device 542, which is coupled to mass storage interface 540. The system memory 538 and mass storage device 542 are communicatively coupled to the ASIC 534 to permit data to be read from, or written to the system memory and possibly the mass storage device.

The mass storage device 542 is implemented as a magnetic hard disc or any other magnetic or optical mass memory device that is capable of storage large amounts of data. Computer readable instructions or data, including an application program 544, other program modules 546 and an electronic program guide (EPG) database 548, which specifies the broadcast times and channels of programs can be stored in mass storage device. In addition to the EPG data provided by the second data communication channel, EPG data may be supplied on a regular basis to continually maintain a current schedule of programming at the client system 100. When the client system 100 is associated with the Internet, the data included in the EPG may be downloaded from the Internet. Alternatively, the EPG may be delivered to the client system by using a direct dial communication over standard telephone lines, or by using data transmission over the cable television infrastructure, a satellite network, an over-the-air broadcasting, or any other available medium. Video data 550 is also stored on the mass storage device. As explained below, such data may thereafter be accessed and read out for viewing on the display device.

The client 100 typically communicates with a network server (not shown) and with other remote computers such as computer 552 as will be understood by those skilled in the art. Communication over a Wide Area Network 556 is facilitated by a serial port interface 554 that is interposed between the system bus 536 and a modem 558, or other appropriate means for establishing communications over a WAN 556. The client system is also capable of transmitting information via the network (e.g., the Internet) by direct dial communication over standard telephone lines, or by using any other available communication medium as described above.

The client system 100 also includes a video output circuit 560 which may include a video encoder and/or a video converter. The video encoder assigns a code to frames of video data that are transmitted across a video image link and switches between analog and digital formats as necessary. Similarly, audio output circuit 562 can include an audio converter to provide the necessary switching between analog and digital formats.

The use of multiple digital tuners and one or more digital recording devices provides numerous advantages in implementing the present invention. For example, live television controls may be provided to further enhance the viewing experience. That is, such controls may be employed to pause for a particular time, e.g., 30 minutes, or to create instant replays, or to view action with slow motion control, even frame-by-frame, based on the live broadcast television signal. In a preferred embodiment, the client system automatically records enhancements so that the viewer may, at a later time, use interactive enhancements at his or her convenience.

The invention provides various user interface enhancements in the form of graphical and informational elements that overlay a portion of the display screen. As explained below, these enhancements aid the viewer in making informed decisions concerning available television programming.

One such user interface enhancement is a television navigation tool. The navigation tool provides improved interoperability with viewers as it guides the viewers to currently available events of a particular type across one or more networks. Thus, in one embodiment, the invention guides the viewer to sporting events that are currently available by presenting a listing of such events in a navigation display area on the screen. The event listing presented in the navigation display area may also be filtered according to the viewer's preferences. That is, the viewer may only be interested in currently available football games. The navigation tool may in this instance be utilized to present only the currently available football games, such as the National Football League games currently in progress on a given Sunday afternoon.

In accordance with one feature of the invention, the information presented in the navigation display area is based on filtered enhanced sports scheduling data that presents up-to-date information to the viewer. For example, icons may be utilized to indicate a particular event identified in the display area is currently in progress and/or a condition in that event has occurred or is about to occur. Thus, the navigation display area only displays those items that are currently available to the viewer. In this embodiment, a user may select an appropriate program by selecting that portion of the navigation display area corresponding to the desired program. The system then automatically tunes to the channel corresponding to that program identified in the navigation display area. In addition, the display may present information such as events that will be available in the future.

To present such information to the viewer, the client system 100 shown in FIG. 5 is operable to extract the Event Identifier associated with the data provided in the generated content stream. The system then searches a previously delivered enhanced sports schedule, which also contains associated Event Identifiers. This permits the system to automatically tune to the program corresponding to the Event Identifier based on a selection thereof by the user.

As discussed above, the Event Identifier data is associated with other generated content such as, for example, real-time indicators, Alerts, DVR trigger information, and other enhanced content. To provide this information to the client system for enhancing the viewing experience, the client system executes one or more application programs. These are based on one or more underlying data engines for processing the received content. Table 1 below identifies exemplary application programs that may be built on top of associated engines. As shown, an exemplary sports application program creates navigation tools such as the “On now” tool. This program is built on top of a data processing engine adapted to process received real-time indicator data. Similarly, game alerts, such as player alerts and time in/time out alerts are provided with the use of an Alert processing engine. For providing game indexing, a DVR engine performs the function of extracting indexing information. Also, an Enhanced content processing engine enables the presentation of content such as game preview information used in conjunction with DVR features of the invention.

TABLE 1

| | | | Television | | |
|---|---|---|---|---|---|
| Engine | Sports | News/Finance | Programs | Music | Movies |
| Real-time | “On now” | Story segments | “On now” | Radio, song | “On now” |
| indicators | navigation | | navigation | list | navigation |
| Alerts | Player alerts, | News alerts and | Guest | Band starts | Celebrity alert |
| | time in/time | tune | Appearances | playing | |
| | out alerts | | on Talk | | |
| | | | Shows | | |
| DVR | Game | Indexed news | Indexed | Indexed | Indexed show |
| | indexing | program | Award | Music video | of movie |
| | | | Shows. | | review or |
| | | | Record | | trailers |
| | | | portions of | | |
| | | | shows | | |
| | | | (monologues) | | |
| Enhanced | Game | Related Content | | Discography, | Filmography |
| content | previews with | w/record button | | related artists | review w/ |
| | record button | | | | record buttons |

Other application programs may be implemented to use the same underlying processing engines. For example, an application related to delivery of News may employ the real-time processing engine for providing viewer indication of currently available story segments. Similarly, the application may employ the Alert processing engine for providing News alerts and tuning capabilities. As with the game indexing function performed with respect to the above described sports application program, the News application may employ the DVR engine to process indices for news programs. In one embodiment, the application displays an alert if a video segment about a viewer's favorite company is about to begin as part of an ongoing news program on another channel. In this example, the ongoing news program has been previously processed and logged, and an Event ID was assigned to the video segment that is mapped to the local channel that will be displaying the video segment. Then, the Event ID is mapped to the IP data comprising the alert. When the alert is displayed, stating “Tune Now for Report on Company X!”, the viewer can select the alert and then tune into the video segment about his or her favorite company. Table 1 above also illustrates a Music application that provides a navigation tool to currently available digital radio programs or a song list of available music-related television programs, as explained in greater detail below. The Alert processing engine may be employed in this example to create notifications such as when a band on a particular television starts playing. The DVR processing engine is employed to process indices corresponding to music video programs. Finally, a Movies application provides a navigation tool to currently available movies. The Alert processing engine may be used in this instance to create notifications of a particular type of scene, such as a love scene, involving a celebrity. The invention may be used process indices for other types of programs as well, such as preview programs and “Infomercials.”

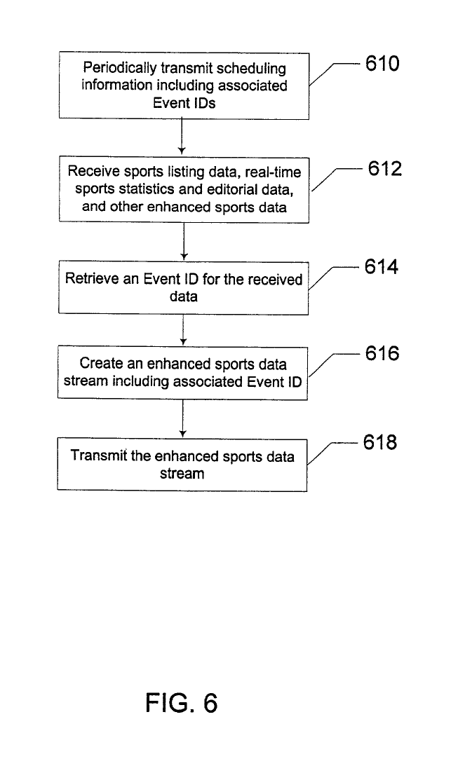

FIG. 6 is a flow chart illustrating certain operations of the Sports Content Aggregator 402(1) shown in FIG. 4. For creating data streams with tunable Alert information that may be transmitted to one or more client systems, an enhanced sports schedule is first created and transmitted to the Broadcast Server 114, and finally to one or more client systems, as shown at a block 610 in FIG. 6. As explained above, such schedule information includes, for a particular sporting event, an associated Event Identifier. Then, during the occurrence of the event, the Sports Content Aggregator 402(1) receives sports listing data, real-time sports information, sports statistics and editorial data, and other sports enhanced data, as shown at a block 612. As mentioned above, the Sports Content Aggregator 402(1) also retrieves an Event Identifier for these data, as shown at block 614. Next, at block 616, the received content is associated with local channel information according to the Event Identifier. At block 618, the Aggregator 402(1) creates an enhanced sports data stream, including the associated Event Identifier, for transmission. Finally, at a block 620, the enhanced data stream is then transmitted to the Broadcast Server 114 and finally to the one or more client systems. As explained above, these steps may be performed by other service provider and/or server components as well.

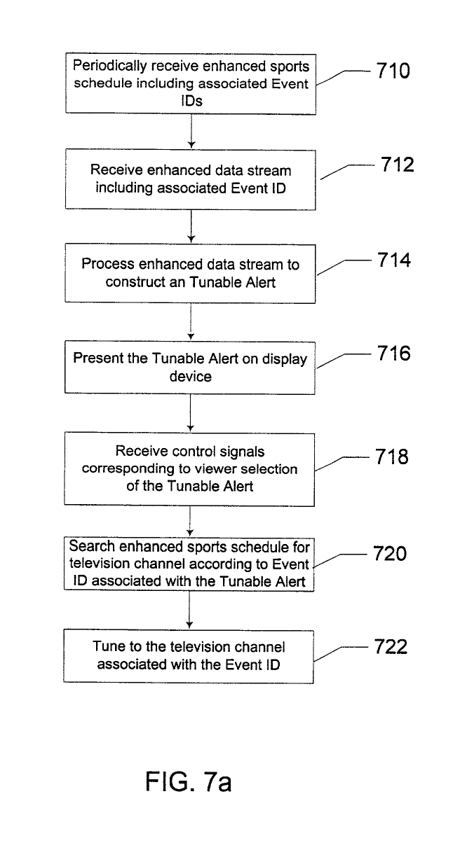

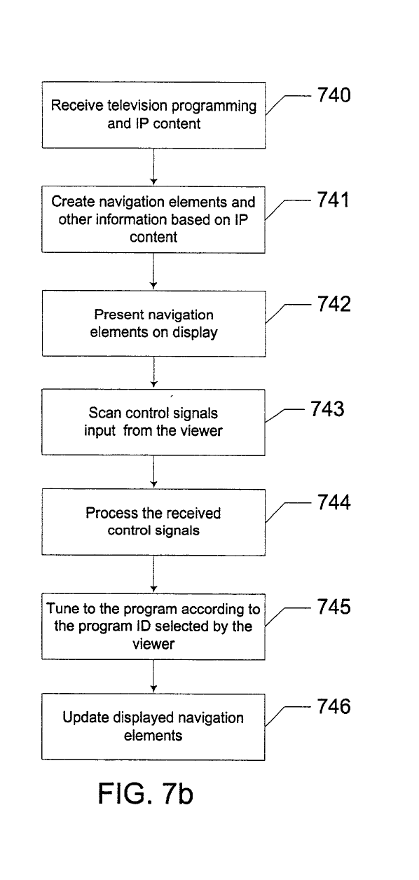

FIG. 7a and FIG. 7b illustrate flow charts in accordance with the two exemplary embodiments of the client system 100 for enabling a tunable alert. In FIG. 7a, the client system periodically receives an enhanced sports schedule with associated Event Identification data, as shown at a block 710. An enhanced data stream, which also includes Event Identification data, is also received at a block 712. At block 714, the client system constructs a tunable Alert based on the received enhanced data stream. As explained below, the Alert may provide information concerning an event that is about to occur in some other sporting event. At block 716, the tunable Alert is presented on the display device. Upon receiving a control signal corresponding to the viewer's selection of the tunable Alert at a block 718, the client system searches the enhanced data stream for television channel according to the Event Identifier associated with the tunable Alert, as shown at a block 720. Finally, at a block 722, the client system tunes to the television channel associated with the Event Identifier.

FIG. 7b shows an operational flow chart of an application program, executing on the client system 100, to create a navigation guide according to another embodiment of the invention. In this embodiment, the enhanced content is associated with a corresponding television program at the client system. Execution of the program begins at step 740. In this step, broadcast programming data and IP content are initially received by the client system. As noted above, the programming data and the IP data are associated with their own unique identification information. Next, at step 741, the system operates to create navigation elements and other enhanced content based on the received IP content. As explained below, this step includes creating certain buttons, Alerts or other real-time indicators that inform the viewer of certain events or the active status of related television programs not currently being viewed. In addition, the system maps the program and content identification data to permit the IP content to be wrapped around the television program as presented to the viewer. Thereafter, at step 742, the client system 100 presents a navigation guide having one or more navigation elements on the display. In many instances, the system also presents a viewing window for displaying a currently viewed program.

At step 743, the system then control signals or other input information received from the viewer. These signals correspond to user selection of a desired program by highlighting or otherwise selecting a navigation element on the display. They are usually entered via the remote input unit 526 shown in FIG. 5. The system then processes the input control signals at step 744. Next, at step 745, the system operates to tune the broadcast program selected by the user. Finally, at step 746, the system updates the presented navigation elements and the viewing window.

While the Alerts shown in FIG. 6, FIG. 7a and FIG. 7b have been “tunable,” Alerts that enable the client system to tune to an appropriate channel based on a previously associated Event Identifier, the invention may also be used to provide other types of Alerts. Such Alerts typically invoke another particular action by the client system. For example, an Alert sometimes triggers actions such as an extendable video recording. This may occur when a sporting event goes into overtime or extra innings. Another example of such an alternative type of Alert is a speculative record Alert. This Alert causes a client system to record an event that is of particular interest, even though the viewer did not request the system to record the event. For example, one type of speculative recording alert selected by the user causes the DVR engine to record all basketball games in the final 2 minutes. Thus, in this embodiment, an alert is transmitted to notify the client engine that a game is in the final 2 minutes. The alert corresponds to an Event ID, and the DVR then tunes to the channel specified by the Event ID to record the program. Another example of this feature is to speculatively record all games that enter an overtime period, all award shows that are in the last half-hour (on the assumption that the most important awards are presented then), or all late night talk shows in the first 10 minutes to record the monologues.

Although “tunable” alerts have been described, the present invention also enables the broadcast of alerts that may simply inform a user that an event of interest is about to occur to devices without tuners. For example, if a news program is about to discuss a company, an alert may be sent to an interested user's cell phone. The cell phone alert will simply inform the user that currently a program is being broadcast that is about to discuss the company of interest. The user can then either find a nearby television or other tunable device (such as a computer with a tuner card) to watch the program or can request that the program be recorded on the customer's home recording machine. In this embodiment, the cell phone, PDA, or other non-tuner device is also downloaded the enhanced theme schedule that relates IP data to television program listings (as customized for the user). When the user selects the alert, the alert in this example merely displays the programming information or provides an option to remotely record the show.

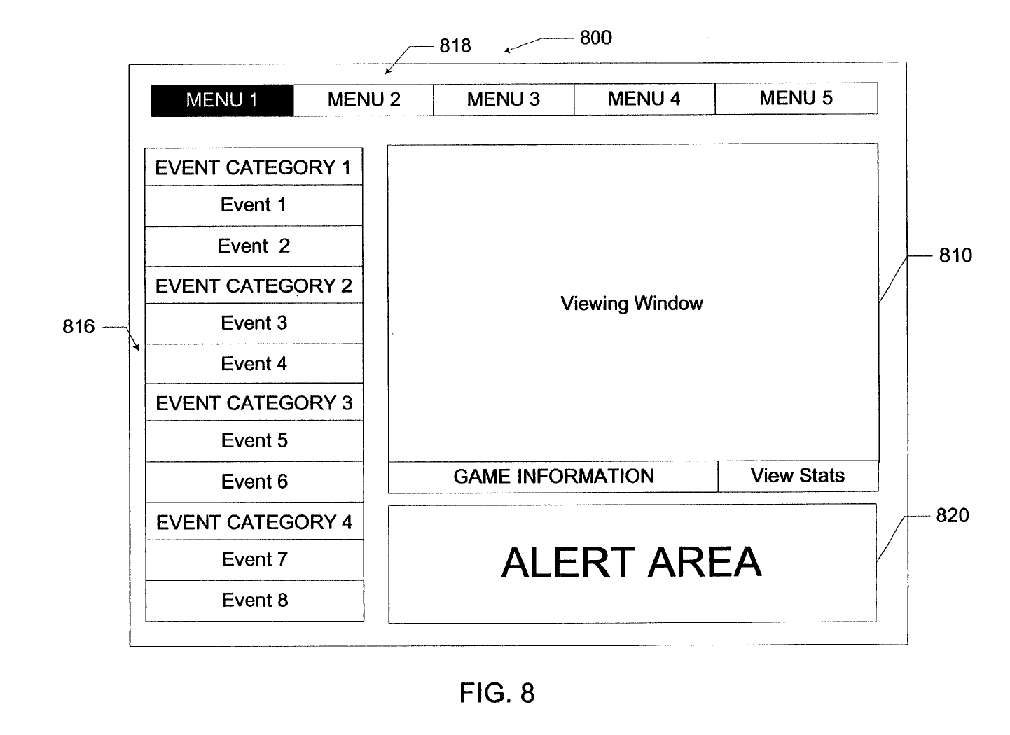

FIGS. 8 through 15 illustrate user interfaces or displays rendered by an application program or programs using the data services delivered according to the invention. In these embodiments, the user interface has several unique display areas: a program viewing display area, a navigation guide area, and an Alert display area. The program display area is generally used to view television programming such as a particular sporting event. While in a navigation operational mode, this display area is reduced to a window size that only uses a portion of the display screen. The program viewing area may be resized based on an input request by the user. It should be understood, however, that the invention is not limited in any way to the specific manner in which the various window elements, such as the navigation guide and the video display area, are placed on the screen in the described embodiments.

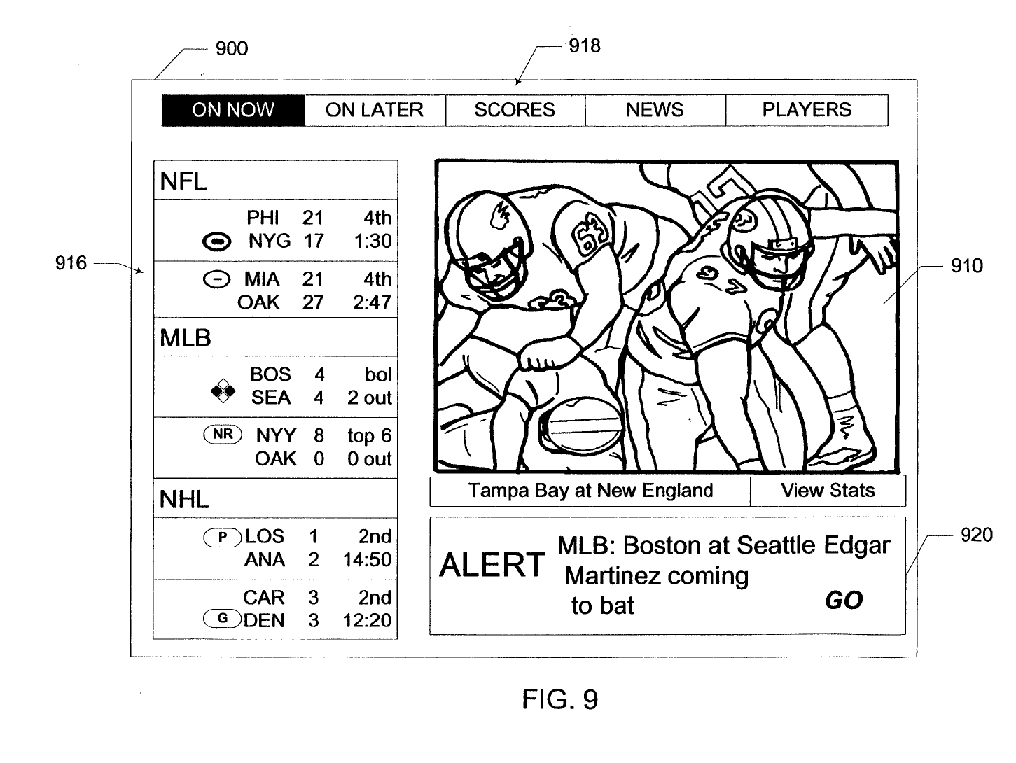

FIG. 8 shows the general layout of a novel navigation guide 800. The navigation guide is segregated into a program viewing window 810 and associated buttons, such as the “Game Information” and “View Stats” buttons shown in FIG. 8. These buttons provide access to additional information concerning the program currently being presented in the viewing window 810. Such information may be resident on the client system or the system may access a Web site that contains such information. In addition to the viewing window, the screen display contains various navigation sections. These are shown in FIG. 8 as a navigation guide or dashboard area 816 and a coarse navigation bar 818. As explained in conjunction with FIG. 9 below, the coarse navigation bar 818 provides a coarse filter for the types of information presented in navigation guide area 816. That is, in FIG. 8, the viewer has selected a “Menu 1” button in the coarse navigation bar that causes the system to present the specific navigation elements in the display area 816.

In addition to the coarse filtering provided by the navigation bar 818, the elements presented in the guide area 816 are logically grouped by event category. That is, the currently available programs, in this case sporting events, are grouped according to event type. Thus, Event Category 1 program offerings may include the currently available National Football League games. Event Category 2 programs may include Major League Baseball games and so on.

FIG. 9 shows a specific implementation of a navigation guide corresponding to the general screen layout described above. In this exemplary navigation guide, a program display window 910 presents a currently available football game, as well as buttons located proximate to the viewing window for further information concerning the game. For example, if the viewer selects a “Tampa Bay at New England” button, the system accesses additional information concerning the broadcast. Similarly, a “View Stats” button causes the system to present statistical information concerning the program.

The navigation guide 900 also provides coarse filters in the form of the menu items located in a coarse navigation area 918. In FIG. 9, the viewer has selected an “On Now” button that filters the currently available sporting events in the navigation guide area 916. The guide area 916 comprises navigation elements that are further segregated by event type. In the illustrated embodiment, the currently available NFL games are displayed as a collection of navigation elements. Likewise, navigation elements corresponding to available Major League Baseball games, as well as National Hockey League games, are collected and displayed as groupings.

As described, each of the navigation elements in the guide area 816 has certain information to assist the viewer in the decision-making process. For example, the first navigation element shown in FIG. 9 corresponds to the broadcast of a currently available football game, Philadelphia against New York. Real-time indications concerning the score and time remaining are presented. Other visual cues, such as a highlighted football in this navigation element, provide up-to-date information concerning game status such as the team currently possessing the football. The highlighting also signifies that the game is currently active.

In a second navigation element shown in FIG. 9, corresponding to the broadcast of a game involving Miami and Oakland, a visual cue in the form of a dimmed or non-highlighted football indicates that the game is currently inactive. This advantageously provides one important cue to the viewer, namely, the active status of other available sporting events. The active status of other events may, of course, be provided by other visual cues, such as through the lighting or darkening of the navigation element, or even through a tunable “time-in/time-out” Alert, as explained below.

The navigation tool creates other visual cues to provide real-time information concerning currently active baseball games, such as the team at bat, runners on base, score and inning. Finally, exemplary visual cues created for currently available hockey games inform the viewer of a power play or the scoring of a goal, as shown in the navigation elements in FIG. 9.

In accordance with another aspect of the invention, various data may be presented in conjunction with the enhanced sports schedule data presented in the navigation guide area. In particular, the screen display may also include a display area in which real-time event Alerts may be displayed to the viewer. This provides up-to-date information as to an event or action that either recently occurred or is about to occur in one or more of the currently available programs that are not being displayed in the display area. Since the Alerts include associated Event Identification data, they enable the client system to automatically tune to the channel associated with the Alert upon selection by the user.

In FIG. 9, a tunable Alert display area 920 presents real-time notification concerning an event in another active broadcast program. The Alert shown in FIG. 9 corresponds to one of the currently active baseball games in this scenario. It informs the viewer that a certain item of interest to the viewer is about to occur. In this case, a specific player is about to bat. The Alert window includes a “GO” button to permit the user to tune to the television broadcast. Thus, as with the navigation elements, the Alerts include Event Identification data to permit association with corresponding programming.

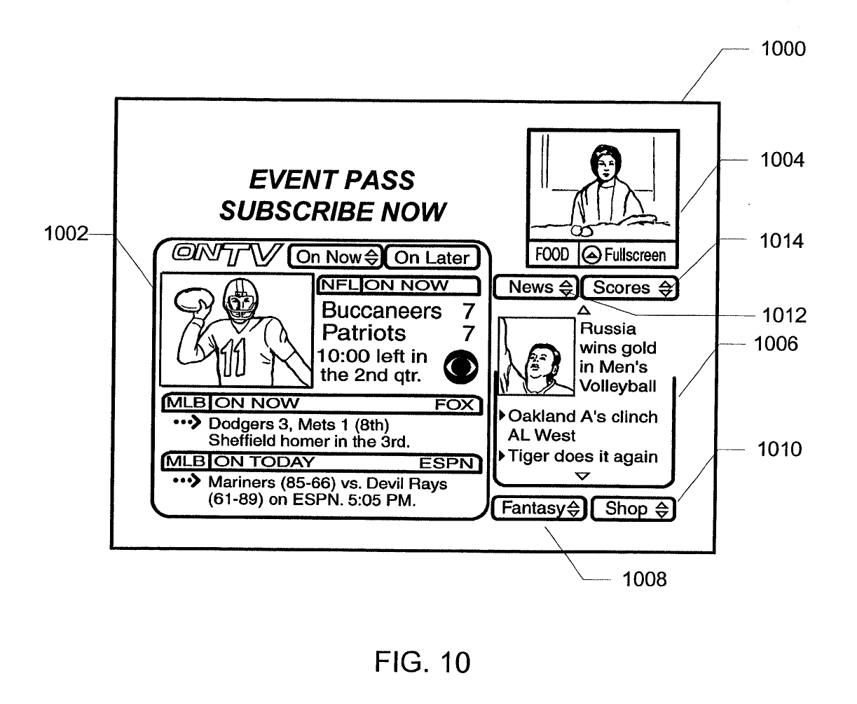

FIG. 10 illustrates a navigation screen 1000 according to a further embodiment of the invention. This navigation screen displays available broadcast television programming that is also filtered to correspond with various category types, albeit somewhat differently than the embodiments of FIGS. 8 and 9. The first program category relates to sporting events, as presented in a first viewing window 1002. A second display window or viewing area 1004 presents other viewing options. Such options are also grouped according to a specific interest category, such as cooking programs. Other display windows may also be utilized. For example, FIG. 10 illustrates a display window 1006 that presents information concerning news items of a specific category of interest.

In addition to viewing windows, the display 1000 includes viewer selectable buttons or controls. In the display screen shown in FIG. 10, such additional controls include a “Fantasy” button 1008 to permit information to be displayed concerning individual players, or groups of players, assigned to the viewer's Fantasy sports team. When selected, the system tunes to an appropriate channel, or accesses a Web site, that provides statistics and other information concerning specific teams or individuals as described by the viewer. In addition, a “Shop” button 1010 is used to direct the viewer to advertising or promotional items related to the programming being offered. A “News” button 1012 and a “Scores” button 1014 are also selectable to cause the system to deliver content, or a hyperlink that contains such content, concerning these topics as well.

In order to navigate through the various display screens or to select a desired program, the viewer preferably uses the input control pad 526 shown in FIG. 5. When the user has selected a display area or a display element that corresponds to available television programming, that display element will be presented as highlighted. Alternatively, the color of the display area may change to indicate that the user has selected the display area. As explained above, the data presented by the client system includes a previously associated Event Id. When the user selects a desired display area, the system looks up the appropriate channel in the previously delivered enhanced sports schedule and automatically tunes the television to that channel, which displays the selected programming.

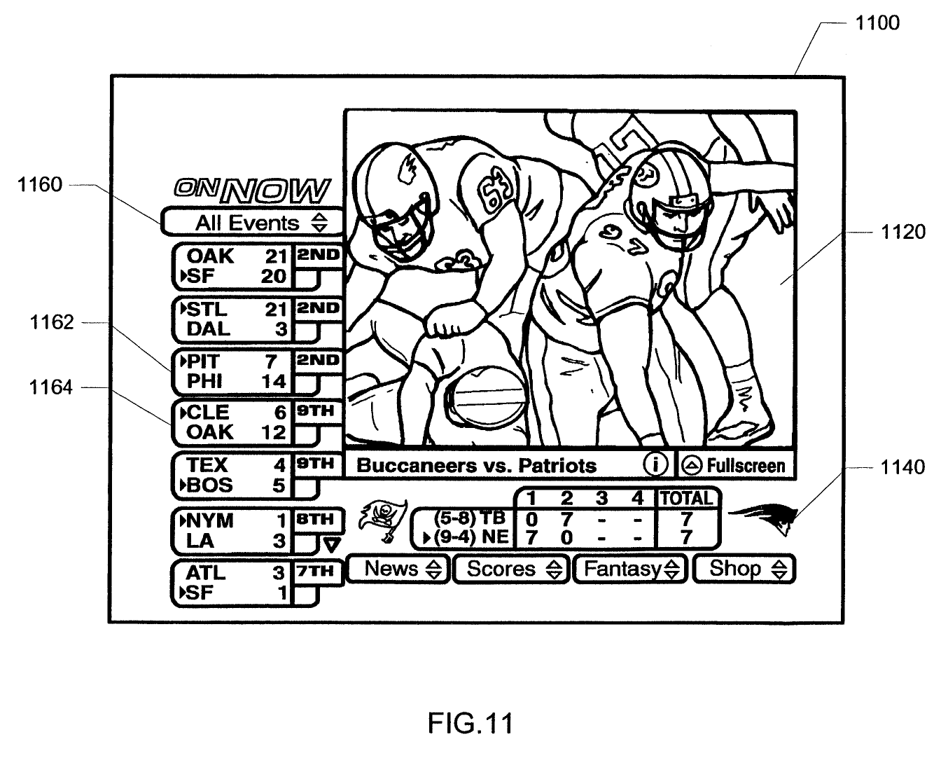

FIG. 11 illustrates another example of a navigation guide 1100. The presented navigation guide 1100 is segregated into a first display window area 1120, a navigation area 1160, and an information area 1140. The navigation area 1160 is further separated into one or more navigation elements such as navigation elements 1162 and 1164. In accordance with one aspect of the invention, the displayed navigation elements correspond to currently available programming selections of a given type. Thus, for example, the navigation elements shown in FIG. 11 correspond to currently available sporting events. When the viewer selects a desired navigation element such as element 1162, the system will automatically tune to that program and it will be displayed in the viewing area 1120. The display area 1120 includes various buttons such as a “Full screen” button that permits the user to exit from a navigation mode and to view a full screen display of the programming.

For providing an enhanced experience, the navigation elements are updated to provide information, preferably in real-time, to the viewer. Thus, in the embodiment shown in FIG. 11, the scores for the currently available sporting events, as shown in the navigation area 1160, are updated and presented to the viewer. Other icons are utilized to provide additional information in the navigation display area. For example, an icon indicating possession of the football, or the team currently at bat, are also presented to the viewer. In accordance with an embodiment of the invention, such information is merged together with the enhanced sports schedule data presented in the navigation display area of the screen.

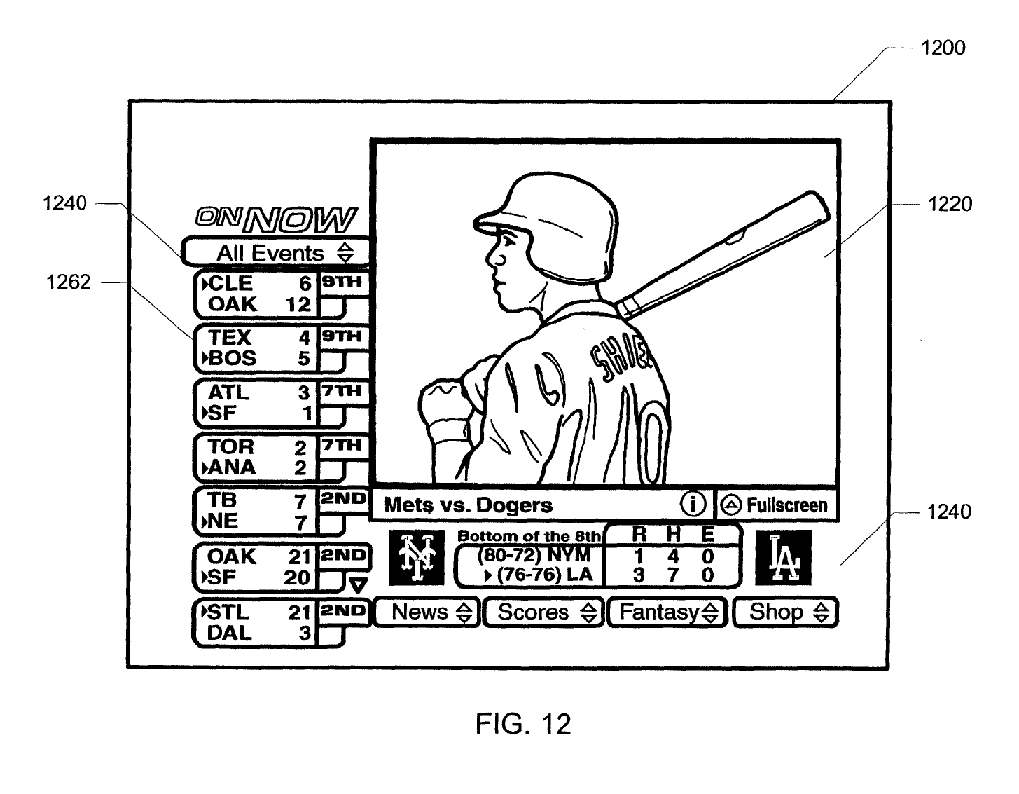

FIG. 12 illustrates a screen display 1200 that is similar to the display screen 1100 shown in FIG. 11, in that it includes a viewing display area 1220 and a navigation area 1240. In this instance, however, the viewer has selected programming of a slightly different type, namely, a currently active baseball game instead of a football game. According to the invention, the navigation display area 1240 is then updated to present other viewing options according to the viewer's preferences. That is, the navigation elements such as element 1262 are reordered as compared to the screen shown in FIG. 11 to present other options that are most likely of interest to the viewer based on the program being viewed. In addition, the navigation elements in the navigation display area 1220 are updated to reflect current scores as well as other important information.

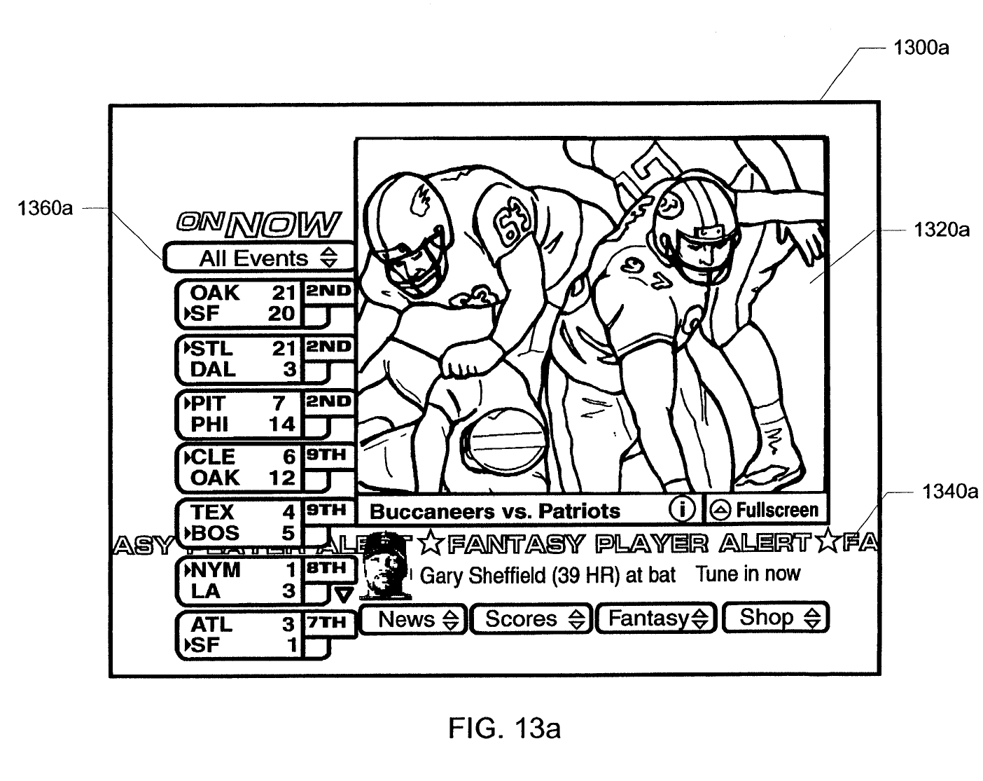

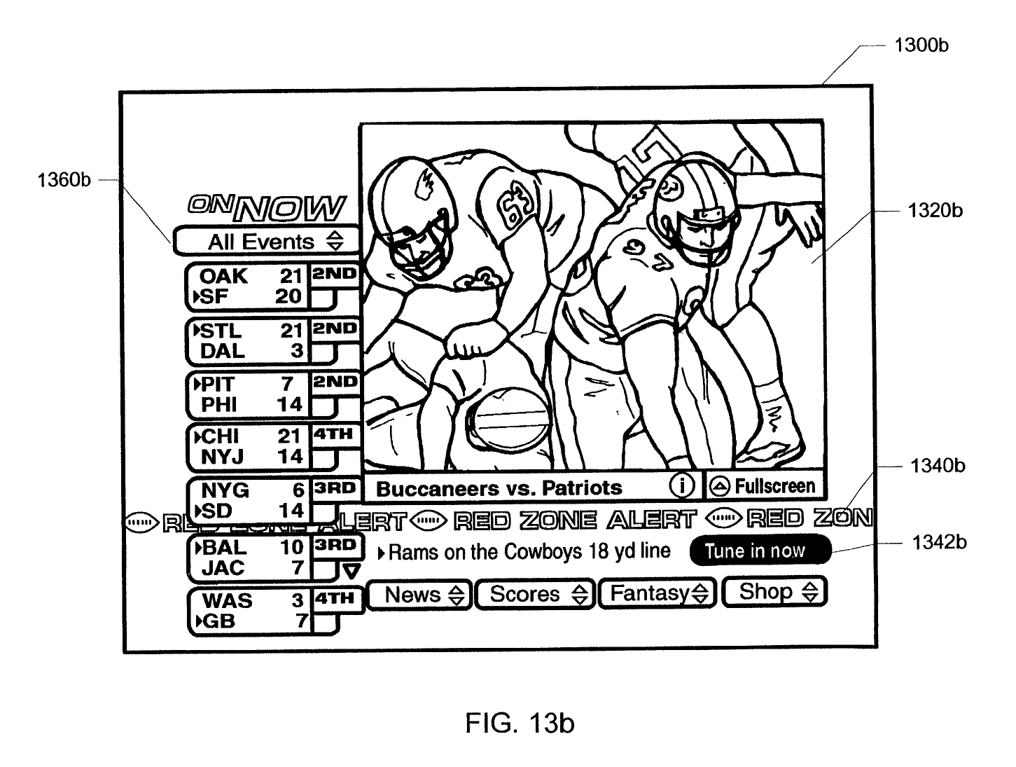

FIG. 13a illustrates a further display screen 1300a that employs one type of Alert indicator according to the invention. As with the embodiments in FIGS. 11 and 12, the display is segregated into a viewing area 1320a and a navigation guide area 1360a. The navigation elements presented in this area of the display are similar to those described above. FIG. 13a also illustrates an Alert display area 1340a that is utilized to provide specific information of interest to the viewer. In this instance, the screen displays an alert corresponding to a player in which the viewer may have a particular interest. For example, the alert may correspond to a Fantasy player that is about to bat in another currently available sporting event.

FIG. 13b illustrates another type of Alert that may be used in accordance with the invention. In this instance, an Alert display area 1340b presents information concerning an event that is about to occur in another broadcast program. As shown, a textual message is provided to the viewer to the effect that one team has just moved the football into the “Red Zone,” namely within the opponent's 20-yard line, and is about to score a touchdown. The viewer may decide to view that program by simply selecting an appropriate button presented on the display, shown in FIG. 13b as a “Tune in now” button 1342b. In response to viewer selection, the system then automatically tunes to the program corresponding to the Alert display area 1340b. Numerous additional Alerts may be created in accordance with any number of defined game rules. These include the occurrence of a scoring play, such as a touchdown in football or a run in baseball. Also, Alert notifications concerning individual athletes may be created any time the athlete performs, or is about to perform, a task.

Digital video recording features are also integrated in a DVR engine executed by the client system according to the invention. That is, the client system processes received real-time and other data services to provide enhanced DVR features. As explained above, the Broadcast Service generates triggers corresponding to game indices to permit storage, playback and viewing of recorded game segments. These include real-time event notifications concerning items of interest that correspond to specific points in the recorded video stream. In addition to the game play events described above, triggers are created notifying the client that a game being recorded has been prolonged, or even that a game of significant interest should be recorded based on profile information of the viewer. In the case of receipt of notification that a recording should be prolonged, the system automatically employs an Auto-extend feature to avoid loss of overtime or other unpredictable program overruns.

In a preferred embodiment, the client system uses the DVR engine along with one or more components to create a Playback application. As explained below, such Playback applications are typically specific to an event or theme, such as a sporting event, a sports highlight program, news, movies, music or the like.

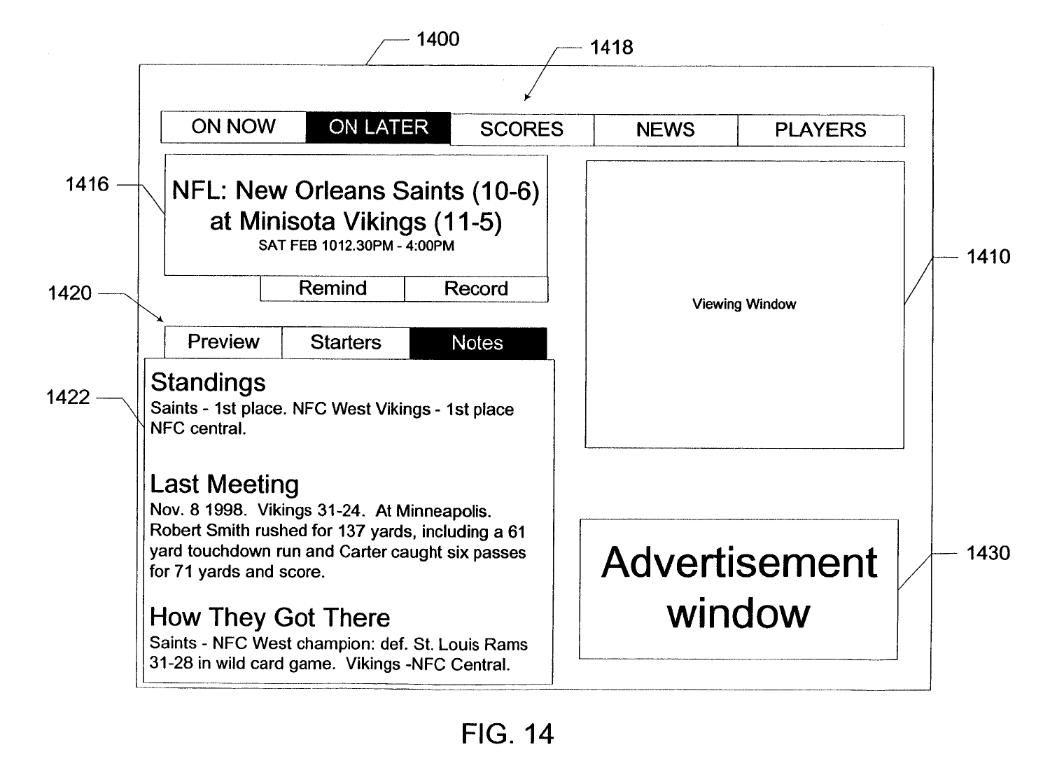

FIG. 14 illustrates a display screen that uses IP content to provide DVR services to the viewer. In this instance, the viewer has selected an “On Later” control in the coarse navigation bar 1418 on the display screen. This action causes the system to display sporting events that will be broadcast at some future time in the navigation guide area 1416. In addition, the display presents domain-specific enhanced content concerning the future event in an information display area 1422. As shown in FIG. 14, such information includes historical facts and other items of interest. The display also presents “Remind” and “Record” buttons that permit user selection of these features.

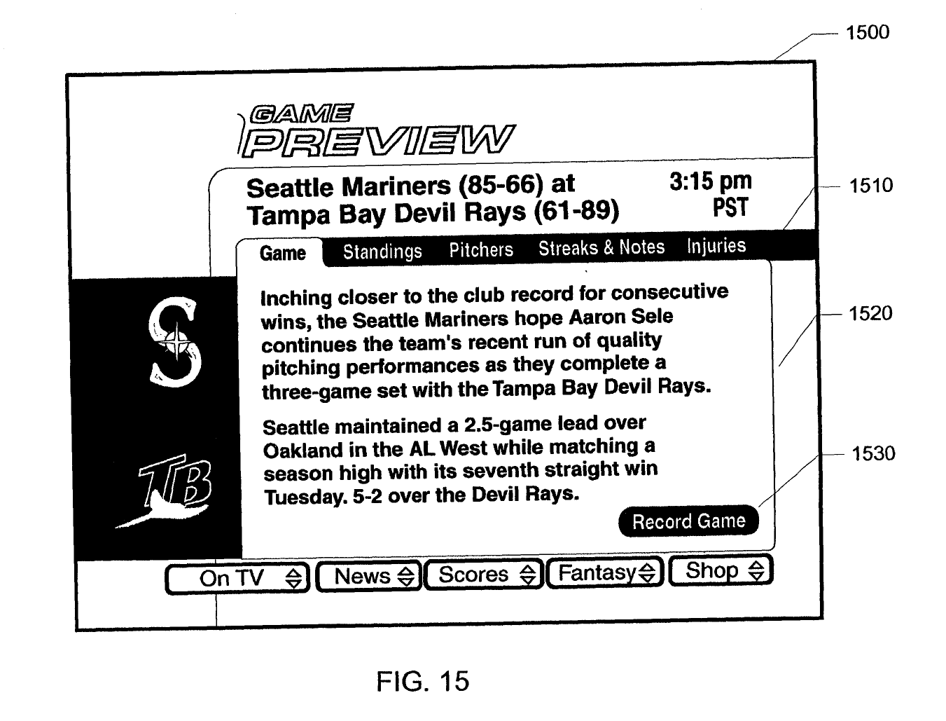

FIG. 15 illustrates an informational screen display showing preview information according to a further embodiment of the invention. For providing information concerning future programming that the viewer may wish to record, a preview or attraction display screen 1500 may be presented. When the invention is used in conjunction with the delivery of sporting events, the preview screen may provide an analysis concerning the importance of the game or like information in a preview viewing area 1520. A “Record” button 1530 enables the viewer to record the program through selection thereof. Other information relevant to the selected game is displayed by highlighting associated buttons listed in a operation bar 1510 to enable viewer navigation among a “GAME” button; a “STANDINGS” button; a “PITCHERS” button; a “STREAKS & NOTES” button; and a “INJURIES” button. These buttons correspond to additional static and/or dynamic information related to the program.

The invention also enables the creation and use of DVR navigation tools based on context sensitive domains. For example, in a recorded football game, the invention permits a viewer to “intelligently skip” to discrete points of interest in the football game recording, such as to the beginning of a quarter, to certain player action, to game highlights only, or from play to play in the game. Alternatively, the viewer may opt to simply skip from play-to-play within the football game. Intelligent game recordings may be developed in other sports based on content created in accordance with game-specific rules. The invention is also used to enhance music, news or movie recordings. For example, the indexing feature may be used to enable a viewer to skip to those portions of a news program or group of news programs of interest.

The invention creates a plurality of indices by associating received event logs with the appropriate locations of the recorded video on the storage medium. As explained above in the case of an indexed sports broadcast, the Sports Content Aggregator 402(1) captures and packages event logs concerning a television program as a plurality of DVR index files. The index files are transmitted to the client system that associates the index file or files with a corresponding recording, if one has been obtained by the client system.

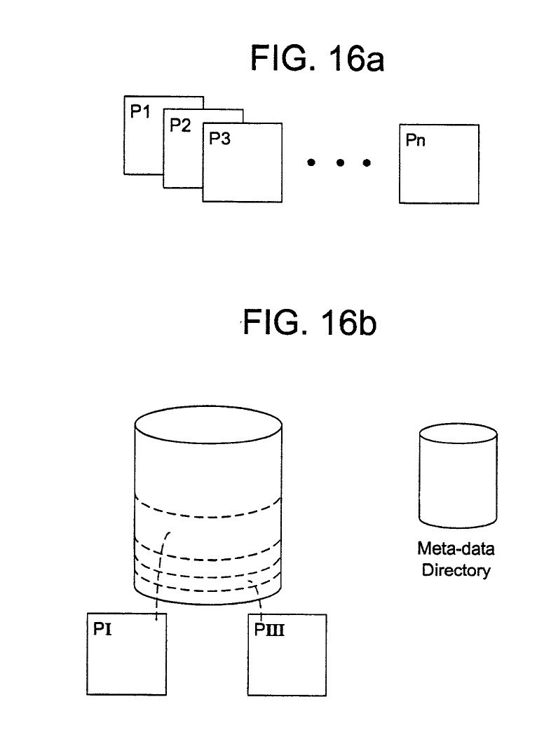

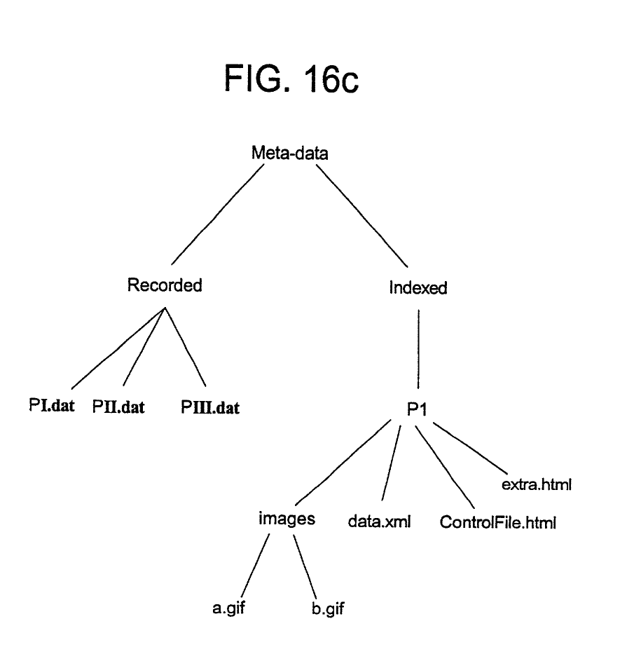

FIGS. 16a through 16c illustrate one way to associate received DVR index files with a video file stored on the client system storage medium. In this example, various data packages, each of which may contain program index files, are downloaded to the client system. These data packages are shown in FIG. 16a as packages P1, P2, P3 . . . PN. The data packages typically include a program DVR index file and a Control File (or a pointer to a Control File). As explained above, the DVR index file contains event index logs for the program, which in the case of a football game, includes indices of plays, highlights and sometimes additional features of the broadcast. A Control File is a file that generally includes user interface elements and scripting code to present a user interface to the user to facilitate playback control of a recorded video program. The Control File may provide an entry point where control is passed from the client operating system to a Playback Application. The Control File can present a user interface, or load and invoke other files to display alternative display elements that make up the user interface to the Playback Application. In a preferred embodiment, the Control File is written in markup language, such as HTML or FLASH 5 from Macromedia, Inc., and optionally contains scripting code such as JavaScript, Perl or Visual Basic. The Control File may optionally contain, or point to, code written in other languages such as C++, Java, or C#.

The system maintains a meta-data directory of recorded programs, index files and control files. FIGS. 16b and 16c show a storage media containing a meta-data directory for this purpose, having entries for recorded programs PI and PIII. The recorded video data for the recorded programs PI and PIII are stored in another partition of the storage medium, diagrammatically shown on the left side of FIG. 116b. In addition to entries for the recorded programs, the meta-data directory also contains an entry for an associated index file P1 and an entry for an associated control file P1, which is placed in the directory as a result of a match with the program entry PI.

When the package is downloaded, a data package handling service residing on the client system is called to perform the function of mapping the package to a recorded program, if a recorded program exists. The package handling service first determines whether a corresponding program has been recorded. This association may be performed various ways, such as with the Event ID or other information uniquely associating the package with a recorded program. As explained above, the Event ID may be obtained by mapping heterogeneous Ids previously assigned to the package into a single homogeneous Event ID system, or the Event ID may be derived from or be the same as a pre-existing universal ID system. In this instance, arguments to the method that performs this function include scheduling and type information concerning the program, and an Event ID.

When a match occurs, the package handling service places an entry for the matched index file, and any other associated files, in an Index File directory. As shown in FIG. 16c, the service creates a new directory entry for the indexed program, P1, and places that entry into the Indexed File directory. The service also renames the index file and places an entry data.xml into an Index subdirectory. The service also renames the control file and places an entry ControlFile.html into a control file subdirectory. The index and control files are then stored in memory. As shown in FIG. 16c, the service may optionally receive other related data to enhance the user interface for the indexed program. In FIG. 16c, the service also receives image files a.gif and b.gif and additional HTML files and places entries into appropriate subdirectories for the P1 indexed file. The related files are also stored on the storage medium.

Other data packages received by the client system are handled in a similar manner. Thus, when the packaging handling service is called to handle the next data package, P2, no match will be found since there is no corresponding recorded program entry in the meta-data directory. Thus, data package P2 will be discarded. However, data package P3 will be associated a recorded program PIII. Thus, entries concerning the P3 index file and P3 control file will be placed in the meta-data directory. When no match with a recorded program is found, the package handling service discards the data package.

The event indices are matched with video segments of a recorded program during playback of the recording. When the viewer selects playback of the recording, the recorded program is located. Based on the entries in the meta-data directory, the DVR engine loads the associated DVR index file and control file. The control file typically includes code (such as scripting code) to initiate certain operations such as to begin playback. Among other things, the DVR engine then builds an event data structure including the events obtained from the associated DVR index file. When the viewer provides an input corresponding to the selection of an event such as a skip to the next play, the DVR engine performs a lookup in the event data structure to obtain a time index for the next play. The time index is a time offset from the beginning of the recorded program. Since time sequence information is also provided with the stored video file, the DVR engine then determines the appropriate video segment corresponding to the time offset in the event data structure and causes the system to begin playback at that video segment. Other event indices are handled in the same manner, namely, by obtaining a time offset or index from the beginning of the program and locating the appropriate video segment corresponding to the time index.

In addition to information concerning the starting point of each tagged event, the indices received by the client system preferably contain other tagged data. In the football example described above, such additional tagged data includes the type of play, yards gained, athlete name, and a description of the event. Thus, at the client system, different levels of personalization can be applied to the tagged event data in order to display preferred data to the user. For example, the client system may instruct the DVR engine to apply filtering techniques such as XML transforms to the data to allow the user to view only preferred data that is a subset of the recording, and to even more intelligently skip to the parts of the DVR recording of interest to the user during playback.

In this way, if the user is interested in the performance of a particular athlete, the user could easily skip to highlights that concern that athlete. In an embodiment involving an indexed Sports Highlight television program, the Playback application can be configured to select (and display) only the highlights of the user's favorite sports teams. Alternatively, in the case of playback of a news show, the user could configure client system to browse and intelligently skip to news regarding the user's favorite companies, or favorite news items, or locale specific news.

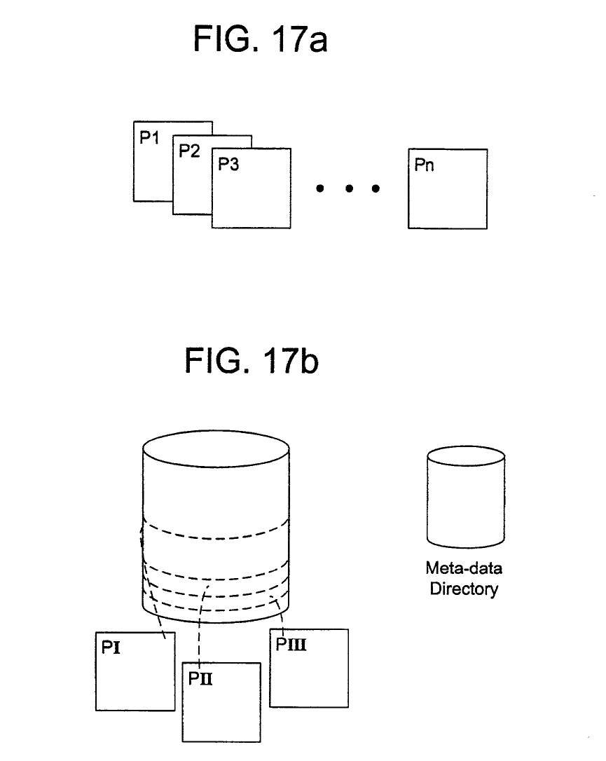

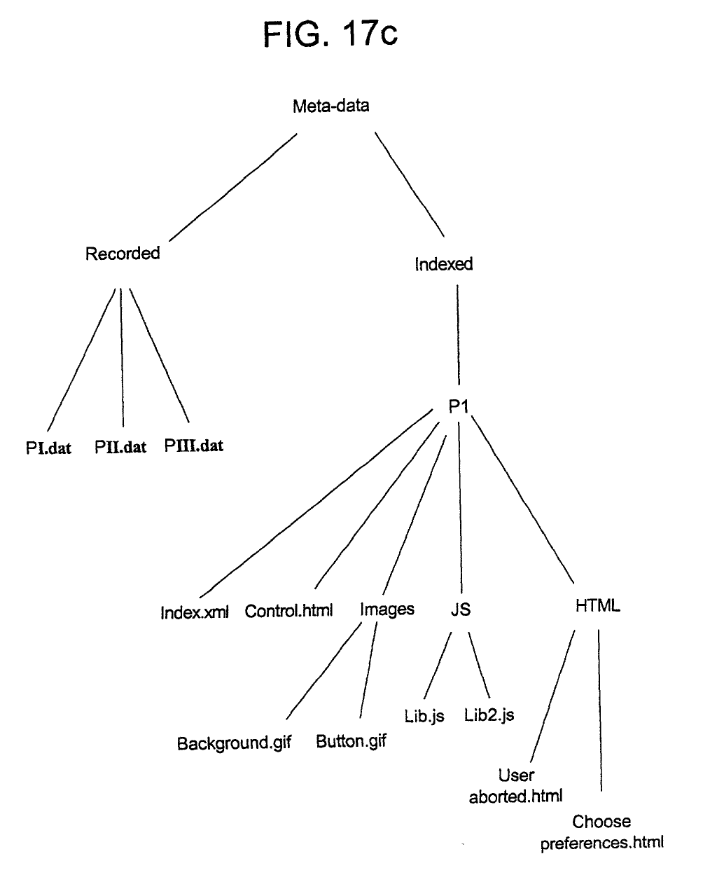

FIGS. 17a through 17c illustrate an association of various enhanced files with a DVR index file. In this instance, various additional components are downloaded to the client system to enable creation of a Playback application that is associated with the DVR index file. As shown in FIG. 17b, three recordings PI, PII and PIII are stored on the storage medium. Thus, as seen in FIG. 17c, a meta-data directory includes entries P1.dat, P2.dat and P3.dat. corresponding to the recordings stored on the storage medium. However, in the example illustrated in FIG. 17c, only one of the recordings, P1.dat, includes an associated downloaded program DVR index file P1. In this case, the index file entry is denoted in the directory structure as “Index.xml.” The meta-data directory also contains entries for various components of an associated Playback application. These include a Control File, shown in FIG. 17c as “Control.html,” that serves as an entry point to pass control from the client operating system to the Playback application. In addition to the index file entry and the control file entry, several subdirectories include entries for files such as GIF files, JavaScript code, and HTML pages. In the implementation shown in FIG. 17c, a GIF subdirectory contains entries for downloaded GIF files such as “Background” and “Button” files. Similarly, a JavaScript subdirectory contains entries for various JavaScript libraries. Finally, an HTML subdirectory contains entries for “UserAborted” and “ChoosePreferences” files.

When the user enters this Playback application, control is initially passed to the Control.html page. This page, in turn, invokes other pages in the directory, or may pass control to other html pages. In this way, the Playback application can be implemented as a series of HTML pages, scripting code such as JavaScript, GIF files, JPEG files, FLASH code, or even one or more Dynamic Linked Libraries (DLLs) that are compiled for a television platform. In addition to receiving the various files as a downloaded package, the Playback application can itself decide the files to be loaded and displayed to the user.

While the Playback application has been described thus far in conjunction with a single DVR recording, those skilled in the art will appreciate that such an application may be associated with multiple indexed recordings to provide specific services. For example, if the user desired to watch a particular athlete in multiple events, the invention could be used to implement an application that accesses indexed data from all such events to provide the specific video playback desired by the user.

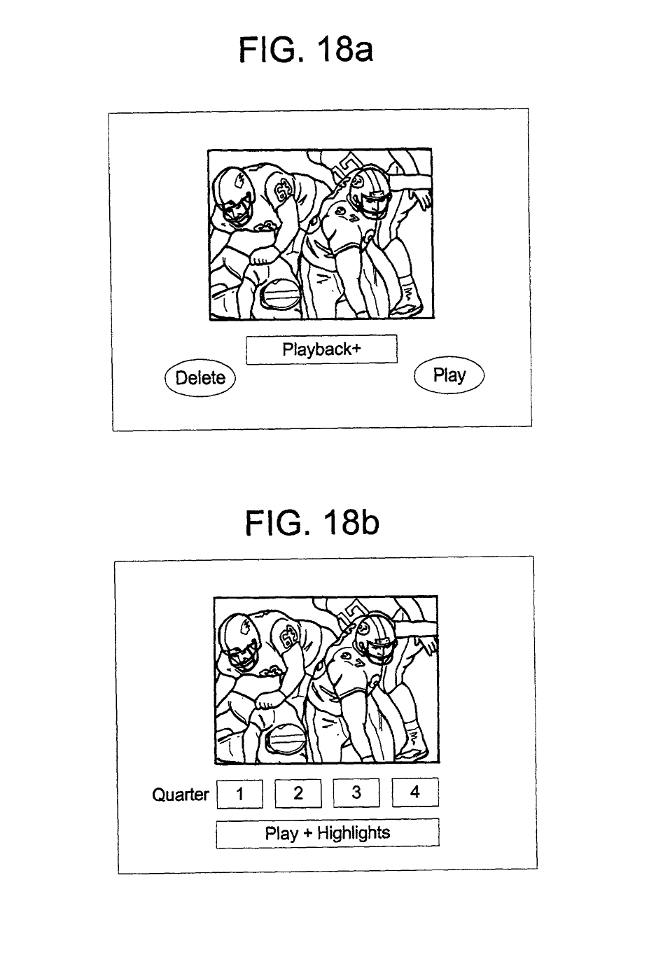

FIGS. 18a and 18b illustrate a user interface that may be used in conjunction with the invention in providing playback of a football game. In FIG. 18a, a display 1800 is partitioned into a television viewing window 1810. The interface presents a “Playback+” icon 1812 that notifies the viewer that the recording is a “smart indexed” recording. In addition, the interface presents a “Play” button 1814 in the event the viewer desires to watch the entire program. Also, the interface presents a “Delete” button 1816 to permit deletion of the recorded program. If the user selects “Playback+” button 1814, the client system may present a smart playback interface, as shown in FIG. 18b. In this example, a display 1820 similarly presents a viewing window 1822. The interface includes selector buttons 1826 corresponding to context sensitive locations in the video file, namely, the beginning of the quarters of the recorded football in the above example. Also, the interface presents a “Highlights” bar 1824 that permits the viewer to skip to highlights of the recorded program. The “Playback+” button may alternatively be implemented as a pull-down menu or the like to provide various options to the viewer.

In addition to game index files that are used to enhance an entire program, such as an entire football game in the example given above, event logs are also transmitted to the client system in real-time to enhance a televised program as it occurs. That is, the DVR indexing engine may operate to build an event data structure concerning a program as the program is broadcast. In this instance, the indices are associated with video segments stored in a pause storage buffer, and may be used to index the program whether or not it is permanently recorded. The DVR indexing engine then operates to locate the time index in the event data structure and the corresponding video segment in the same manner as described above. Thus, while delivery of the Playback application has been described above in connection with FIGS. 16 and 17 to embodiments in which enhanced content is received after the broadcast program is recorded, the invention may also be implemented to permit user interaction based on enhanced content received during the broadcast program.

The control data provided to the client system may also be used to provide enhancements concerning user interface with the client system. One such feature is a “Skip Override” feature to tie the remote control with the programming. In most instances, selection of a Skip Forward input key on the user's remote control causes the client system to perform a 30 second forward skip in the video, and selection of a Skip Backward causes a seven second backward skip. With the present invention, a Skip Override feature operates to process a received “Skip Forward” input command to perform a next logical skip. This feature permits the viewer to observe an expected response by the client system. That is, when watching a recording of a football game, the viewer will observe a skip to the beginning of the next play, whether or not it follows the preceding play by 30 seconds. Similarly, the Skip Override feature may operate to process a received “Skip Backward” input command to perform a logical skip to the preceding video segment expected by the viewer.

In the currently preferred embodiment, the DVR enhancements are applied to the recording of an entire program. Thus, the video recording is not copied or altered. However, the client system may operate to process and enhance the video recording in various ways. For example, the client system may edit the recording and resave an edited version of the recording according to viewer preferences. In the case of the football example, the client system could process the recording and save only plays, highlights, or certain player action from the recorded football game as a new, abridged video file. This feature may be employed where disk storage space is premium.

Alerts are also provided to the client system to trigger certain actions such as automatically adjusting the record time concerning a recorded program. For example, the record time of a sporting event may be extended when the event lasts longer than expected. Conversely, the record time of an event may be shortened when the event lasts shorter than expected. Also, a speculative record Alert may be utilized which causes the system to begin recording an event such as a game of significant interest. This Alert may be created from profile information of the viewer, such as his favorite team or players, or location.

Finally, the DVR enhancements are sometimes combined, depending on the service. For example, once the speculative record feature is utilized, the client system may thereafter receive either the program, either with or without event log indices, concerning the program that was speculatively recorded.

While the invention has been described primarily in conjunction with the integration of disparate data sources such as real-time IP data, Event Identification data and broadcast television programming, those skilled in the art will appreciate that many other data sources and data types may be integrated as well. For example, in the alternative or in addition to enhanced scheduling data, the invention may be used to integrate real time IP data with Event Identification data so that the user may make an informed decision on the programming of choice.

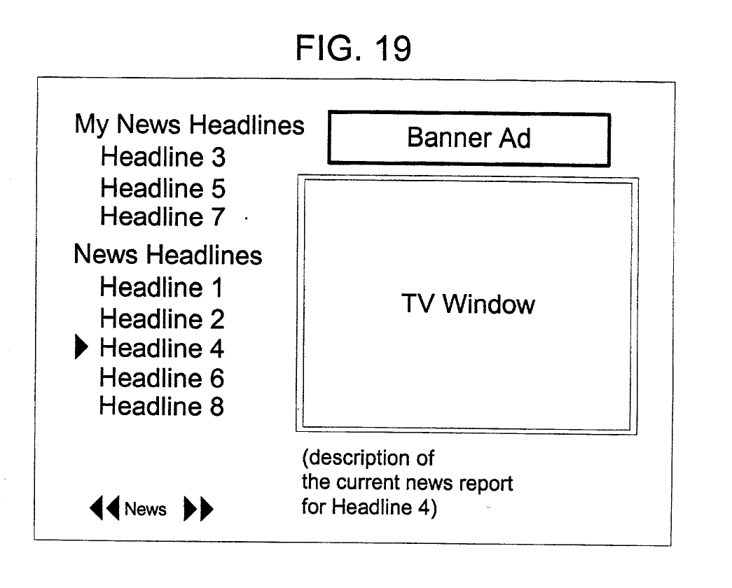

Similarly, the invention also has applicability to television programming other than sports programming. For example, the invention may also be deployed in the context of music, movies and news selections. FIG. 19 illustrates a user interface for navigating between headlines in a recorded news program. In this case, the recorded news program is indexed in the manner described above to include indices for the beginning various news items or segments. In a preferred embodiment, associated titles and a brief description of the news item are also provided in the index file transmitted to the client system. As shown, a News Playback application creates a display 1900 that is partitioned between a television viewing window 1910, an area for advertisements 1912 and a Headline list area 1914. The Headline list area 1914 is further divided between a “My News Headlines” list 1916 and a “News Headlines” list 1918. The News Playback application thus creates the news items lists in accordance with user preferences that have been previously entered. In this way, the playback application may sort news items in various ways. For example, all news items relating to a particular company or industry may by identified by the user. Alternatively, news items relating to a particular subject matter, such as Sep. 11, 2001, may be identified. This is readily enabled by matching the user preference or preferences with the control tagged entries inserted into the indexed data, as explained above.

When the user selects a particular headline in the list such as by selecting a News Headline 1920, a description associated with the headline appears in an area 1922 proximate the television viewing window. As with the embodiments described above, the Headlines items correspond to context sensitive locations in the video file, namely, the beginning of the news item in the program. Selection of one of the Headlines in the list permits the viewer to skip to corresponding item in the recorded news program.

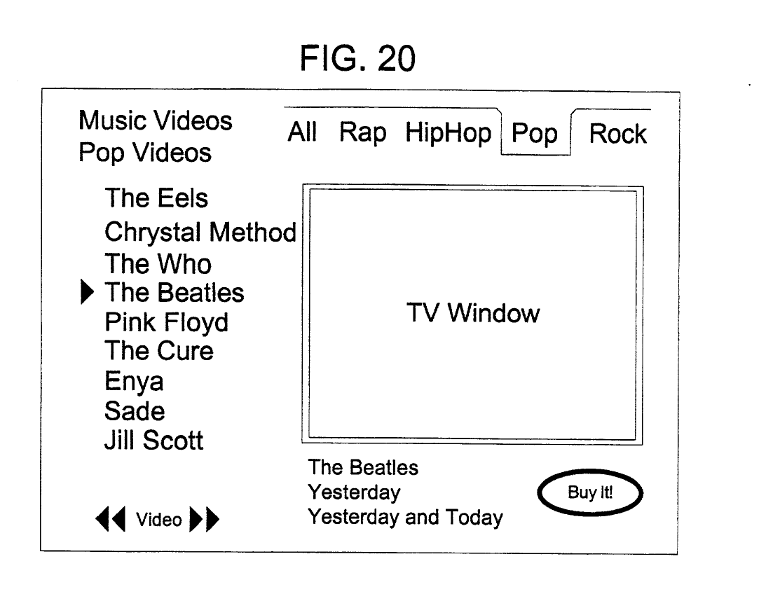

FIG. 20 illustrates a user interface for navigating between recorded music videos. In this instance, programming from various music video channels may be stored and process by the client system. For playback of desired recorded video content, a Music Video Playback application creates a display 2000 that includes a television viewing window 2010, a music genre selection bar 2012, and a playlist 2014 identifying available music videos for the selected genre. The playlist 2014 may be sorted in other ways, such as by artist. As with the News Playback application, when the user selects a particular video title in the list, a description associated with the title is also preferably displayed in a viewing area 2016. The application also presents additional buttons or interfaces such as a “Buy It!” button 2018 to permit the user make purchases as desired. The Music Video Playback application thus creates video lists that may also be sorted by genre and/or user preference. This feature is also performed by matching the genre type and/or user preference or preferences with the control tagged entries inserted into the indexed data, as explained above. When the user selects a particular music video in the list, a description associated with the video in an area 2022 proximate the television viewing window. As with the embodiments described above, the video names correspond to context sensitive locations in the video file, namely, the beginning of the video recording. Selection of one of the music videos in the list permits the viewer to skip to corresponding item in the recording.

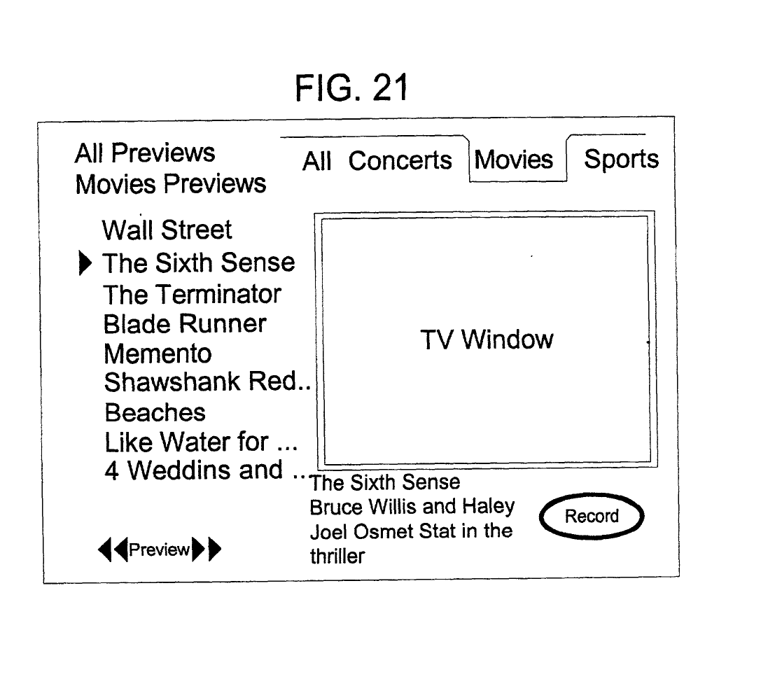

FIG. 21 illustrates a user interface for navigating between movie previews and other offerings. In this instance, a Movie Preview application associates various previews with a title list. The Preview application creates a display 2100 that is partitioned between a television viewing window 2110, an entertainment type selection bar 2112, and a movie list area 2114. When the user selects a particular movie title, a description associated with the headline appears in an area 2116 proximate the television viewing window. This application enables the user to select movies and other entertainment in an “on demand” fashion. The Movie Preview application also presents additional buttons or interfaces such as a “Buy” button 2118 to permit the user make purchases.

Various advantages and features flow from the present invention. In prior systems, electronic programming data and other information was only statically presented to the viewer. Such information was decoupled from the broadcast television programming. In contrast, the present invention permits such data to be combined with real-time data to provide up-to-date information to the viewer. As indicated above, such real-time information may include an alert that a sporting event has gone into overtime or that it is otherwise prolonged. In addition to informing the viewer of programming that may be of interest, this information may be used to prolong the recording of the event or to alert the user to switch to that sporting event. In addition, the use of television controls enables the viewing of multiple video signals, and switching back and forth between the multiple video signals. The controls may be utilized to pause, replay and skip portions of a program being broadcast. This feature permits a viewer to choose to watch only indexed highlights and/or other specific features that would generally enhance the viewing experience.

The invention thus permits aggregation of content and meta-data for multiple television programs in one or more normalized content streams. On the other hand, known program enhancements are provided in multiple program-specific content streams in different content representations. Such known enhancements cannot be aggregated due to the stream retrieval overhead that would be required.

The invention is particularly useful in applications where programming of a specific type is aggregated, filtered in some way, and presented to the viewer. In the above-described embodiment, information concerning a particular subject matter or theme, such as currently available sporting events, is aggregated and presented to the user. The invention may also be employed to aggregate and present information concerning available musical programs, or even in other contexts such as available movies or news items. Accordingly, an enhanced television service meeting the above objectives has been described. It should be understood, however, that the foregoing description has been limited to the presently contemplated best mode for practicing the invention. It will be apparent that various modifications may be made to the invention, and that some or all of the advantages of the invention may be obtained. Also, the invention is not intented to require each of the above-described features and aspects or combinations thereof, since in many instances, certain features and aspects are not essential for practicing other features and aspects. Accordingly, the invention should only be limited by the appended claims and equivalents thereof, which claims are intented to cover such other variations and modifications as come within the true spirit and scope of the invention.

What is claimed is:

1. A method for digitally recording a broadcast television program in an audio/video entertainment system comprising the steps of:
receiving enhanced content including preview information concerning at least one broadcast television program and an event identifier associating the enhanced content with the at least one broadcast television program;
presenting the preview information and a selector button on a video display;
in response to viewer selection of the selector button, causing the entertainment system to automatically tune to the broadcast television program associated with the event identifier when the program is actually broadcast; and
digitally recording the broadcast television program on a storage medium.

2. The invention as in claim 1 further comprising the step of tuning to a second broadcast television program while the digitally recording step is being performed.

3. The invention as in claim 1 wherein the video display is a television receiver.

4. The invention as in claim 1 wherein the preview information corresponds to future sports television programming.

5. A computer program product for use in a network environment having at least one client system and one broadcast server coupled to said network environment, wherein said network environment is a distributed environment capable of delivering broadcast television programming, the computer program product comprising:
a computer usable medium having computer readable code embodied therein for causing the client system to receive the television programming and to receive dynamic content including plurality of program indices corresponding to predetermined time logs for at least one of the programs in the television programming;
computer readable code for causing the client system to store at least a portion of the television programming as at least one program segment on a storage medium;
computer readable program code for associating one of the program indices with the at least one program segment;
computer readable program code for performing a search for the at least one program segment based on the associated program index; and
computer readable program code for causing said client system to display, the at least one television program segment.

6. The invention as in claim 5 wherein the dynamic content includes control data associating the dynamic content with at least one user interface.

7. The invention as in claim 6 further including computer readable program code for creating a plurality of program segments based on the program indices.

8. The invention as in claim 7 further including computer readable program code for automatically skipping forward from the end of a first program segment to the beginning of a second program segment in a skip-forward mode of operation.

9. The invention as in claim 8 further including computer readable program code for automatically skipping backward from the end of a second program segment to the beginning of a first program segment in a skip-backward mode of operation.

10. The invention as in claim 5 wherein the dynamic content received by the client system further includes an event-based indicator, and wherein the computer program product further comprises computer readable program code for adjusting the record time of a television program based upon the event-based indicator.

11. The invention as in claim 10 wherein the computer program product comprises computer readable program code for extending the record time based on the event-based indicator.

12. The invention as in claim 10 wherein the computer program product further comprises computer readable program code for reducing the record time of a television program based upon the event-based indicator.

13. The invention as in claim 5 wherein the dynamic content received by the client system includes an event-based indicator, and wherein the computer program product further comprises computer readable program code for causing the client system to automatically record a television program based upon the receipt of the event-based indicator.

14. A method for creating digital video recording enhancements for a television program comprising the steps of:
creating program event log indices marking events in the program meeting program-specific rules;
creating one or more control files associated with the program event log indices to facilitate receipt of user input at a client system; and
transmitting the program event log indices and the one or more control files to the client system to enable the client system to perform an intelligent filter based on processing of the program event log indices in response to user input.

15. The invention of claim 14 wherein the program event log indices are created as the program is broadcast.

16. The invention of claim 15 wherein the program event log indices are transmitted to the client system in real-time.

17. The invention of claim 15 wherein the program log indices are transmitted to the client system after the recording of a show.

18. The invention of claim 14 wherein the program-specific rules relate to sporting events.

19. The invention of claim 18 wherein the program-specific rules relate to football.

20. The invention of claim 14 wherein the program-specific rules relate to news events.

21. The invention of claim 14 wherein the program-specific rules relate to televised music programs.

22. The invention of claim 14 wherein the program-specific rules relate to televised movies.

23. The invention of claim 14 wherein the program-specific rules relate to preview programs.

24. The invention of claim 14 wherein the program specific rules relate to infomercials.

25. The invention of claim 16 wherein the event log indices are transmitted in a format that enables the client system to define multiple playback modes of operation.

26. The invention of claim 14 wherein the program event log indices are formatted in the Extensible Markup Language.

27. The invention of claim 14 wherein the program event log indices are transmitted to the client system in a batch mode.

28. The invention as in claim 16 wherein additional versions of the program log indices are transmitted to the client system in a batch mode.

29. The invention as in claim 16 wherein the event log indices are transmitted in a peer-to-peer networking environment.

30. The invention as in claim 16 wherein the one or more control files are used to create a playback application by the client system.

31. A method for processing video recording enhancements in a client system adapted to receive television programming comprising the steps of:
receiving the television programming;
storing the television programming as a recorded program;
receiving program event indices developed according to one or more defined rules applied to the television programming; and
associating the program event indices with corresponding segments in the recorded program.

32. The invention of claim 31, wherein at least one of the plurality of defined rules requires an event log to be captured upon the occurrence of a certain action in the television programming.

33. A method for enabling an intelligent skip feature in digital video recording apparatus that is capable of storing one more recorded programs comprising the steps of:
receiving a plurality of program event log indices developed in accordance with program-specific rules;
associating at least certain ones of the event log indices with corresponding intervals in a recorded program; and
locating the corresponding interval in the recorded program.

34. The method as in claim 33 wherein the receiving step includes receiving an index file including the plurality of program event indices.

35. The method as in claim 34 wherein the index file further includes control data.

36. A digital recording device operable to perform an intelligent skip comprising:
a storage medium containing a recording; and
a Digital Video Recording engine executing on a data processing device adapted to receive a plurality of context sensitive program indices, to associate at least certain ones of the program indices with corresponding segments of the recording, and to locate the corresponding segment in the recording.

37. A method for playing back digitally recorded programming in an audio/video entertainment system comprising the steps of:
receiving enhanced content concerning the recorded programming;
receiving index information concerning the digitally recorded program;
associating the enhanced content with the index information;
creating a playback application from the enhanced content including functionality for creating an interactive user interface on a video display;
presenting the interactive user interface including at least one selector button on the video display;
in response to viewer selection of the selector button, causing the entertainment system to automatically locate at least one of the plurality of indices; and
presenting digitally recorded programming corresponding to the at least one located index.

38. The invention as in claim 37 further comprising the step of recording broadcast television programming while the interactive user interface is being presented.

39. The invention as in claim 37 wherein the playback application includes Markup language files, graphics files, picture files, scripting files, index files and other data.

40. The invention as in claim 37 wherein the steps of receiving enhanced content and the step of receiving index information occur after the programming has been broadcast.

41. The invention as in claim 37 wherein the steps of receiving enhanced content and the step of receiving index information occur during a broadcast of programming.

42. A computer program product for use in a network environment having at least one client system and one broadcast server coupled to said network environment, wherein said network environment is a distributed environment capable of delivering broadcast television programming, the computer program product comprising:
a computer usable medium having computer readable code embodied therein for causing the client system to store recorded television programming, to store dynamic content including plurality of program indices corresponding to predetermined time logs for at least one of the programs in the television programming, and to store one or more control and data files;
computer readable code for causing the client system to create a playback application program based on the received one or more control and data files;
computer readable program code for causing the application program to associate one of the program indices with a location in recorded television programming; and
computer readable program code for performing a search for at least one program location based on the associated program index.

43. The invention as in claim 42 wherein the application program includes Markup language files, scripting files and index files.

44. The invention as in claim 43 wherein the application program further includes graphics files, picture files, and other data.

45. The invention as in claim 42 wherein the application program includes computer readable program code for searching a plurality of recorded programs in accordance with a user preference.

46. A method for extending the record time of a broadcast program being recorded by Digital Video Recording apparatus comprising the steps of:
receiving an enhanced user alert during the broadcast program and at least one unique event identifier associating the user alert with the broadcast program;
processing the user alert to determine an extended record time for the broadcast program; and
automatically changing the record time of the broadcast program to the extended record time.

47. A method for altering a determined record time of a televised sporting event in a Digital Video Recording system comprising the steps of:
receiving a user alert containing metadata concerning the duration for the sporting event and a unique event identifier associating the user alert with the televised sporting event;
processing the user alert to determine an altered record time for the televised sporting event; and
automatically recording the televised sporting event for the altered record time.

48. A method for automatically recording a televised event in a Digital Video Recording system comprising the steps of:
receiving a speculative user alert concerning a televised event and at least one event identifier associating the speculative user alert with the televised event;
processing the speculative user alert by the Digital Video Recording system;
determining by the Digital Video Recording system that the event is to be recorded based on information contained in the speculative user alert; and
automatically recording the televised event.
